(19) United States
(12) Patent Application Publication
(10) Pub. No.: US 2026/0369897 A1
(43) Pub. Date: Nov. 19, 2026

(54) MULTI-SECTOR ANTENNA HAVING EFFICIENT MULTI-MODE OPERATION AND METHODS OF OPERATING SAME

(71) Applicant: Outdoor Wireless Networks LLC, Richardson, TX (US)

(72) Inventors: Rui An, Richardson, TX (US); Chengcheng Tang, Richardson, TX (US); XiaoHua Hou, Richardson, TX (US); Zhanming Zhang, Suzhou (CN); Ligang Wu, Suzhou (CN); Fusheng Lv, Suzhou (CN); Fan He, Suzhou (CN)

(21) Appl. No.: 19/751,841

(22) Filed: Jul. 23, 2026

Related U.S. Application Data
(63) Continuation-in-part of application No. 18/652,059, filed on May 1, 2024.

(30) Foreign Application Priority Data
May 4, 2023 (CN) 202310491839.9

(51) Int. Cl. H01Q 25/04; H01Q 3/36

(52) U.S. Cl. CPC H01Q 25/04; H01Q 3/36

(57) ABSTRACT

A multi-mode antenna includes a feed network including a cascaded arrangement of a first phase shifter and hybrid coupler pair, which is responsive to a radio frequency (RF) input feed signal, and a second phase shifter and hybrid coupler pair, which is responsive to an RF feed signal generated at a second output port of the first phase shifter and hybrid coupler pair. First, second and third arrays of radiating elements are provided. The first array is responsive to a RF feed signal derived from a first output port of the first phase shifter and hybrid coupler pair; the second array is responsive to an RF feed signal derived from a first output port of the second phase shifter and hybrid coupler pair; and the third array is responsive to an RF feed signal derived from a second output port of the second phase shifter and hybrid coupler pair.

### CROSS-REFERENCE TO RELATED APPLICATION

The present application claims priority under 35 U.S.C. § 120 as a continuation-in-part of U.S. patent application Ser. No. 18/652,059, filed May 1, 2024, which in turn claims priority to Chinese Patent Application Serial No. 202310491839.9, filed May 4, 2023, the entire content of each of which is incorporated herein by reference

### FIELD OF THE INVENTION

The present invention relates to radio communications and, more particularly, to multi-sector antennas used in cellular communication systems.

### BACKGROUND

A 3-sector antenna is a type of antenna system commonly used in cellular networks; it is typically designed to divide a coverage area into three 120° sectors or zones, and is configured to generate a directional beam that provides coverage to each of the three sectors. As shown by FIGS. 1A-1B, a 3-sector antenna 10 typically uses multiple arrays of radiating elements 12a, 12b, 12c (i.e., multiple “antenna arrays”) to create corresponding beams 14a, 14b, 14c that provide coverage to each of the corresponding sectors. As will be understood by those skilled in the art, the work state of these antenna arrays 12a, 12b, 12c may be controlled using relatively complex remote radio unit (RRU) technology.

### SUMMARY OF THE INVENTION

A multi-mode antenna according to embodiments of the invention includes a feed network and a plurality of antenna arrays (“arrays”) responsive to feed signals generated by the feed network. In some of these embodiments, the feed network can include a cascaded arrangement of a first phase shifter and hybrid coupler pair, which is responsive to a radio frequency (RF) input feed signal, and a second phase shifter and hybrid coupler pair, which is responsive to an RF feed signal generated at a second output port of the first phase shifter and hybrid coupler pair. In addition, the plurality of arrays may include: (i) a first array (ARRAY1) responsive to a RF feed signal derived from a first output port of the first phase shifter and hybrid coupler pair, (ii) a second array (ARRAY2) responsive to an RF feed signal derived from a first output port of the second phase shifter and hybrid coupler pair, and (iii) a third array (ARRAY3) responsive to an RF feed signal derived from a second output port of the second phase shifter and hybrid coupler pair. In some of these implementations, the hybrid couplers may be selected from a group consisting of parallel λ/2 open branch couplers, multi-segment hybrid couplers, and coplanar waveguide (CPW) circle hybrid couplers, etc. Higher and wider band performance may also be achieved using hybrid couplers formed from electronic chips.

According to an additional embodiment of the invention, the feed network may further include a third phase shifter and hybrid coupler pair, which is responsive to an RF feed signal generated at the first output port of the first phase shifter and hybrid coupler pair. In this embodiment, the first array may be responsive to an RF feed signal derived from a first output port of the third phase shifter and hybrid coupler pair; and a fourth antenna array may be provided, which is responsive to an RF feed signal derived from a second output port of the third phase shifter and hybrid coupler pair.

According to further embodiments of the invention, the first, second and third arrays may be configured to radiate in respective first, second and third sectors of a three-sector antenna, and the feed network may be configured such that the first array is responsive to an RF signal that bypasses the second phase shifter and hybrid coupler pair, whereas the second and third arrays are responsive to RF signals that pass through a cascaded arrangement of the first phase shifter and hybrid coupler pair and the second phase shifter and hybrid coupler pair. In some of these embodiments, the feed network is configured to support, through adjustments to the first and second phase shifters, each of the following seven operating modes: (i) ARRAY1, ARRAY2 and ARRAY3 active, (ii) ARRAY1 and ARRAY2 active, ARRAY3 inactive (iii) ARRAY1 and ARRAY3 active, ARRAY2 inactive (iv) ARRAY2 and ARRAY3 active, ARRAY1 inactive, (v) ARRAY1 active, ARRAY2 and ARRAY3 inactive, (vi) ARRAY2 active, ARRAY1 and ARRAY3 inactive, and (vii) ARRAY3 active, ARRAY1 and ARRAY2 inactive. In addition, relatively fine “analog” adjustments to the first and second phase shifters may enable the feed network to support a plurality of operating modes that are intermediate the seven operating modes, such that one or more of the multiple arrays is only partially active or partially inactive.

According to still further embodiments of the invention, a multi-mode antenna may include first, second and third antenna arrays (ARRAY1, ARRAY2 and ARRAY3) responsive to first, second and third RF feed signals, respectively, and an enhanced feed network. This feed network is configured to generate the first, second and third RF feed signals in response to a radio frequency (RF) input feed signal, and support, through adjustments therein, each of the following seven operating modes: (i) ARRAY1, ARRAY2 and ARRAY3 active, (ii) ARRAY1 and ARRAY2 active, ARRAY3 inactive (iii) ARRAY1 and ARRAY3 active, ARRAY2 inactive (iv) ARRAY2 and ARRAY3 active, ARRAY1 inactive, (v) ARRAY1 active, ARRAY2 and ARRAY3 inactive, (vi) ARRAY2 active, ARRAY1 and ARRAY3 inactive, and (vii) ARRAY3 active, ARRAY1 and ARRAY2 inactive, and a plurality of modes intermediate these seven operating modes. In some of these embodiments, the feed network is configured to include a plurality of phase shifters therein, and each of the seven operating modes is established by a unique setting of these phase shifters. In further embodiments, each of the plurality of phase shifters (e.g., wiper-type, slider-type) is paired with a corresponding coupler within the feed network.

According to additional embodiments of the invention, a method of operating a multi-sector antenna is provided that includes adjusting at least one phase shifter within a cascaded arrangement of a first phase shifter and hybrid coupler pair having an input port configured to receive a radio frequency (RF) input feed signal, and a second phase shifter and hybrid coupler pair having an input port responsive to a RF feed signal generated at a second output port of the first phase shifter and hybrid coupler pair, to thereby switch the multi-sector antenna between at least two of the following seven operating modes: (i) ARRAY1, ARRAY2 and ARRAY3 active, (ii) ARRAY1 and ARRAY2 active, ARRAY3 inactive (iii) ARRAY1 and ARRAY3 active, ARRAY2 inactive (iv) ARRAY2 and ARRAY3 active, ARRAY1 inactive, (v) ARRAY1 active, ARRAY2 and ARRAY3 inactive, (vi) ARRAY2 active, ARRAY1 and ARRAY3 inactive, and (vii) ARRAY3 active, ARRAY1 and ARRAY2 inactive, where ARRAY1, ARRAY2 and ARRAY3 correspond to first, second and third antenna arrays within the multi-sector antenna. In some of these embodiments, the first array (ARRAY1) is responsive to a RF feed signal derived from a first output port of the first phase shifter and hybrid coupler pair, the second array (ARRAY2) is responsive to an RF feed signal derived from a first output port of the second phase shifter and hybrid coupler pair, and the third array (ARRAY3) is responsive to an RF feed signal derived from a second output port of the second phase shifter and hybrid coupler pair. The adjusting operation may also include adjusting at least one phase shifter within the cascaded arrangement to thereby switch the multi-sector antenna into an operating mode that is intermediate at least two of the seven operating modes.

Pursuant to further embodiments of the present invention, multi-mode antennas are provided that comprise a first RF signal input, first through fourth arrays of radiating elements, and a feed network that connects the first RF signal input to the first through fourth arrays of radiating elements. The feed network comprises a plurality of hybrid couplers and a plurality of adjustable phase shifters, where the adjustable phase shifters are configurable to route substantially all of the power of an RF signal that is input at the first RF signal input to a selected one of any of the first through fourth arrays of radiating elements, or to split the power equally between all four of the first through fourth arrays of radiating elements.

In some embodiments, the adjustable phase shifters may be further configurable to route substantially all of the power of the RF signal input at the first RF signal input to any combination of two of the first through fourth arrays of radiating elements or to any combination of three of the first through fourth arrays of radiating elements.

In some embodiments, the adjustable phase shifters may be mechanically adjustable wiper-type phase shifters.

In some embodiments, the plurality of hybrid couplers may comprise first through third hybrid couplers that each have first and second input ports and first and second output ports, where the first hybrid coupler is on an electrical path between the first RF signal input and the second and third hybrid couplers, and wherein the first output port of the second hybrid coupler is coupled to the first array of radiating elements, the second output port of the second hybrid coupler is coupled to the second array of radiating elements, the first output port of the third hybrid coupler is coupled to the third array of radiating elements, and the second output port of the third hybrid coupler is coupled to the fourth array of radiating elements. In some embodiments, a first electrical length of a first transmission path between the first output port of the second hybrid coupler and the first array of radiating elements is different than a second electrical length of a second transmission path between the second output port of the second hybrid coupler and the second array of radiating elements. In some embodiments, a third electrical length of a third transmission path between the first output port of the third hybrid coupler and the third array of radiating elements may be different than a fourth electrical length of a fourth transmission path between the second output port of the third hybrid coupler and the fourth array of radiating elements. In some embodiments, the first electrical length may be equal to the fourth electrical length and/or the second electrical length is equal to the third electrical length.

In some embodiments, the radiating elements in the first through fourth arrays of radiating elements are dual-polarized radiating elements, the RF signal is a first RF signal, the plurality of hybrid couplers are a first plurality of hybrid couplers, the plurality of adjustable phase shifters are a first plurality of adjustable phase shifters, and the feed network is a first feed network that is coupled to the first polarization radiators of the dual-polarized radiating elements in the first through fourth arrays of radiating elements, the multi-mode antenna further comprising a second RF signal input and a second feed network, where the second feed network connects the second RF signal input to the second polarization radiators of the dual-polarized radiating elements in the first through fourth arrays of radiating elements, the second feed network comprising a second plurality of hybrid couplers and a second plurality of adjustable phase shifters, where the adjustable phase shifters in the second plurality of adjustable phase shifters are configurable to route substantially all of the power of a second RF signal input at the second RF signal input to a selected one of any of the first through fourth arrays of radiating elements or to split the power equally between all four of the first through fourth arrays of radiating elements.

Pursuant to further embodiments of the present invention, multi-mode antennas are provided that comprise a first RF signal input, first through fourth arrays of radiating elements, and a feed network that connects the first RF signal input to the first through fourth arrays of radiating elements. The feed network comprises a second hybrid coupler that has a first output that is connected to the first array of radiating elements and second output that is connected to the second array of radiating elements, a third hybrid coupler that has a first output that is connected to the third array of radiating elements and second output that is connected to the fourth array of radiating elements, and a first fixed delay element provided along a second transmission path between the second output port of the second hybrid coupler and the second array of radiating elements so that a first electrical length of a first transmission path between the first output port of the second hybrid coupler and the first array of radiating elements is less than a second electrical length of the second transmission path

In some embodiments, the feed network further comprises a second fixed delay element provided along a third transmission path between the first output port of the third hybrid coupler and the third array of radiating elements so that a fourth electrical length of a fourth transmission path between the second output port of the third hybrid coupler and the fourth array of radiating elements is less than a third electrical length of the third second transmission path. In some embodiments, the first electrical length is equal to the fourth electrical length and/or the second electrical length is equal to the third electrical length.

In some embodiments, the feed network further comprises a third hybrid coupler and first through third adjustable phase shifters, where the first adjustable phase shifter is coupled between the first RF signal input and first and second inputs of the first hybrid coupler, a first output of the first hybrid coupler is coupled to first and second inputs the second hybrid coupler through the second adjustable phase shifter, and a second output of the first hybrid coupler is coupled to first and second inputs the third hybrid coupler through the third adjustable phase shifter. In some embodiments, the first through third adjustable phase shifters are configurable to route substantially all of the power of an RF signal input at the first RF signal input to a selected one of any of the first through fourth arrays of radiating elements or to split the power equally between all four of the first through fourth arrays of radiating elements. In some embodiments, the first through third adjustable phase shifters are further configurable to route substantially all of the power of the RF signal input at the first RF signal input to any combination of two of the first through fourth arrays of radiating elements or to any combination of three of the first through fourth arrays of radiating elements.

Pursuant to still further embodiments of the present invention, multi-mode antennas are provided that comprise a first RF signal input, first through fourth arrays of radiating elements, and a feed network that connects the first RF signal input to the first through fourth arrays of radiating elements. The feed network comprises a second hybrid coupler that has a first output that is connected to the first array of radiating elements and second output that is connected to the second array of radiating elements and a third hybrid coupler that has a first output that is connected to the third array of radiating elements and second output that is connected to the fourth array of radiating elements. The multi-mode antenna is configured to operate in a selected one of a plurality of pre-programmed operating modes that includes an operating mode where about 25% of a power level of an RF signal input at the RF signal input is passed to the first output of the second hybrid coupler, about 25% of the power level of the RF signal input at the RF signal input is passed to the second output of the second hybrid coupler, and about 50% of a power level of an RF signal input at the RF signal input is passed to either the first output or the second output of the third hybrid coupler comprises

In some embodiments, the feed network further comprises a first hybrid coupler and a first adjustable phase shifter that is coupled between the first RF signal input and first and second inputs of the first hybrid coupler. The feed network may also include a second adjustable phase shifter that is coupled between a first output of the first hybrid coupler and first and second inputs of the second hybrid coupler and a third adjustable phase shifter that is coupled between a second output of the first hybrid coupler and first and second inputs of the third hybrid coupler. The feed network may further comprise a first fixed delay element provided along a second transmission path between the second output port of the second hybrid coupler and the second array of radiating elements.

In some embodiments, a first electrical length of a first transmission path between the first output port of the second hybrid coupler and the first array of radiating elements is less than a second electrical length of the second transmission path.

In some embodiments, the feed network further comprises a second fixed delay element provided along a third transmission path between the first output port of the third hybrid coupler and the third array of radiating elements. In such embodiments, a fourth electrical length of a fourth transmission path between the second output port of the third hybrid coupler and the fourth array of radiating elements is less than a third electrical length of the third transmission path.

### BRIEF DESCRIPTION OF THE DRAWINGS

FIG. 1A is a schematic diagram of a 3-sector (120°/sector) antenna having a work state that may be controlled by a remote radio unit (RRU), according to the prior art.

FIG. 1B is a perspective view of a 3-sector antenna according to the prior art.

FIG. 2A is a multi-mode 3-sector antenna having a feed network according to an embodiment of the invention.

FIG. 2B is a multi-mode 4-sector antenna having a feed network according to an embodiment of the invention.

FIG. 3A is a phase shifter and hybrid coupler pair set to a first power ratio, which may be used in the feed networks of FIGS. 2A-2B.

FIG. 3B is a phase shifter and hybrid coupler pair set to a second power ratio, which may be used in the feed networks of FIGS. 2A-2B.

FIG. 3C is a phase shifter and hybrid coupler pair set to a third power ratio, which may be used in the feed networks of FIGS. 2A-2B.

FIG. 3D is a phase shifter and hybrid coupler pair set to a fourth power ratio, which may be used in the feed networks of FIGS. 2A-2B.

FIG. 3E is a phase shifter and hybrid coupler pair set to a fifth power ratio, which may be used in the feed networks of FIGS. 2A-2B.

FIG. 4A illustrates the 3-sector antenna of FIG. 2A set to a first mode of operation by the feed network.

FIG. 4B illustrates the 3-sector antenna of FIG. 2A set to a second mode of operation by the feed network.

FIG. 4C illustrates the 3-sector antenna of FIG. 2A set to a third mode of operation by the feed network.

FIG. 4D illustrates the 3-sector antenna of FIG. 2A set to a fourth mode of operation by the feed network.

FIG. 4E illustrates the 3-sector antenna of FIG. 2A set to a fifth mode of operation by the feed network.

FIG. 4F illustrates the 3-sector antenna of FIG. 2A set to a sixth mode of operation by the feed network.

FIG. 4G illustrates the 3-sector antenna of FIG. 2A set to a seventh mode of operation by the feed network.

FIGS. 5A-5C illustrate a parallel λ/2 open branch hybrid coupler, a multi-segment hybrid coupler, and a coplanar waveguide (CPW) circle hybrid coupler, respectively, which may be used in the feed networks of FIGS. 4A-4G.

FIG. 6 is a block diagram of a multi-mode 4-sector antenna having a feed network according to further embodiments of the invention.

FIGS. 7A-7O are schematic diagrams illustrating the fifteen operating modes of the 4-sector antenna of FIG. 6.

FIG. 8A is a schematic perspective view of a base station according to embodiments of the present invention that includes a radio unit and a base station antenna.

FIG. 8B is a schematic top view of the base station of FIG. 8A.

FIGS. 9A and 9B are schematic diagrams that together illustrate the feed network for one implementation of the antenna includes in the base station of FIGS. 8A-8B, as well as the connections between the outputs of the feed network and the antenna arrays that are included in the antenna.

FIG. 10 is a block diagram of a feed network of a multi-mode antenna according to further embodiments of the invention.

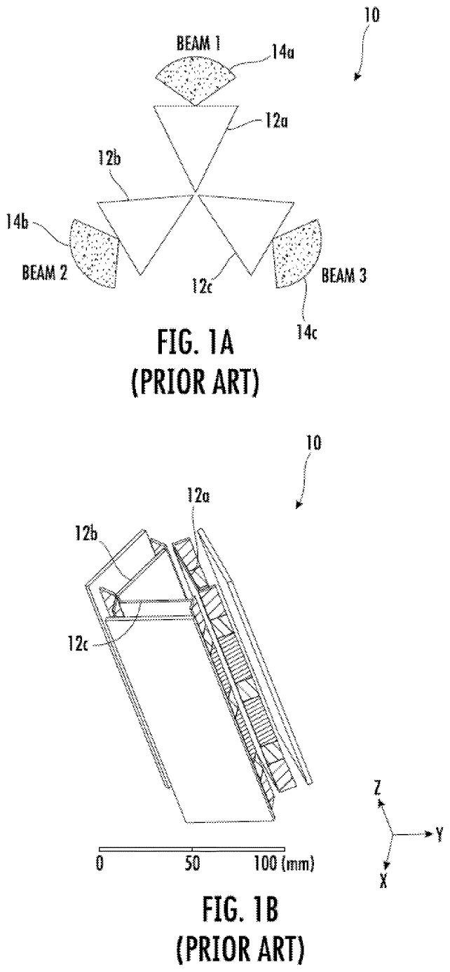

In the figures and specification, two-part reference numerals that include a hyphen may be used to describe elements having more than one instance. Herein, the full two-part reference numeral may be used to refer to individual instances of such elements, while the first part of the reference numeral may be used to refer to such elements collectively.

### DETAILED DESCRIPTION OF EMBODIMENTS

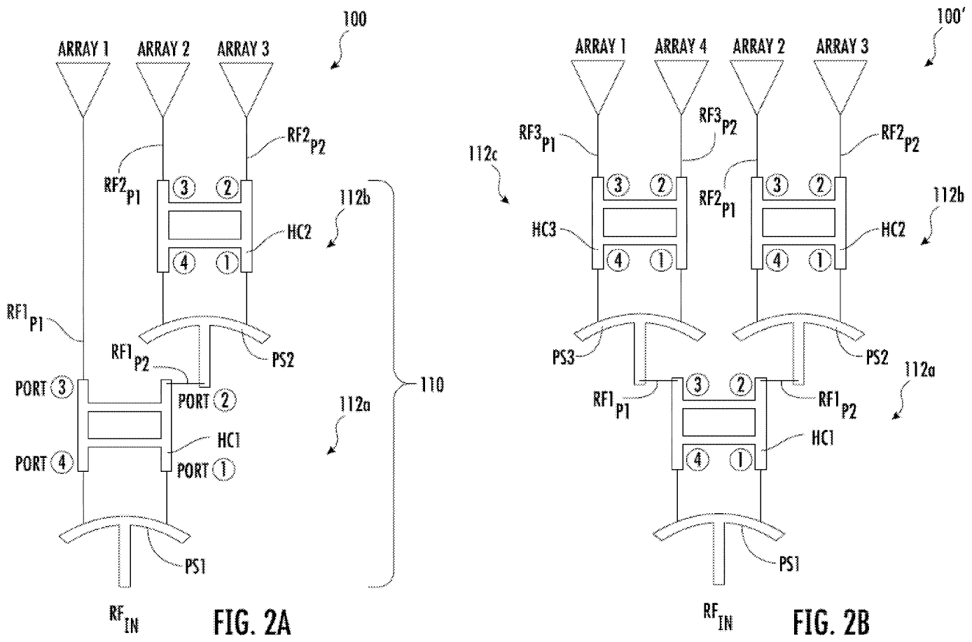

Referring now to FIG. 2A, a multi-mode 3-sector antenna 100 according to an embodiment of the invention is illustrated as including first, second and third antenna arrays (ARRAY1, ARRAY2, ARRAY3) that receive corresponding RF feed signals from a feed network 110. As described hereinbelow, the feed network 110, which may be configured to support relatively low power and low cost “small cell” antenna applications in some embodiments, includes a cascaded arrangement of a first phase shifter and hybrid coupler pair 112a, which is responsive to a radio frequency (RF) input feed signal RF_{IN}, and a second phase shifter and hybrid coupler pair 112b, which is responsive to an RF feed signal RF1_{P2} generated at a second output port of the first phase shifter and hybrid coupler pair 112a. This first phase shifter and hybrid coupler pair 112a is shown as including: (i) a first wiper-type phase shifter PS1 having an input port configured to receive the input feed signal RF_{IN}, and (ii) a first hybrid coupler HC1 having first and second “input” ports (ports 4, 1) electrically connected to a pair of output ports of the first wiper-type phase shifter PS1. Similarly, the second phase shifter and hybrid coupler pair 112b is shown as including: (i) a second wiper-type phase shifter PS2 having an input port configured to receive the feed signal RF1_{P2} generated at the second output port of the first phase shifter and hybrid coupler pair 112a, which corresponds to a second output port (port 2) of the first hybrid coupler HC1, and (ii) a second hybrid coupler HC2 having first and second “input” ports (ports 4, 1) electrically connected to a pair of output ports of the second wiper-type phase shifter PS2.

Furthermore, the first array (ARRAY1) is responsive to a RF feed signal RF1_{P1} derived from a first output port of the first phase shifter and hybrid coupler pair 112a, which corresponds to a first output port (port 3) of the first hybrid coupler HC1, whereas the second array (ARRAY2) is responsive to an RF feed signal RF2_{P1} derived from a first output port of the second phase shifter and hybrid coupler pair 112b, which corresponds to a first output port (port 3) of the second hybrid coupler HC2. In addition, the third array (ARRAY3) is responsive to an RF feed signal RF2_{P2} derived from a second output port of the second phase shifter and hybrid coupler pair 112b, which corresponds to a second output port (port 2) of the second hybrid coupler HC2. As used herein, a signal “derived” from a port of a device includes: (i) a signal generated directly at the port, or (ii) a signal that passes through one or more active and/or passive elements electrically coupled to the port.

Next, as shown by FIG. 2B, the multi-mode antenna 100 of FIG. 2A may be modified by adding a fourth antenna array (ARRAY4) to thereby provide a 4-sector antenna 100′ that can support as many as fourteen (14) modes of operation. In this embodiment, a third phase shifter and hybrid coupler pair 112c may be added to the feed network to thereby drive the first and fourth arrays (ARRAY1, ARRAY4), in response to an RF feed signal RF1_{P1} signal generated at the first output port of the first phase shifter and hybrid coupler pair 112a. This third phase shifter and hybrid coupler pair 112c is shown as including: (i) a third wiper-type phase shifter PS3 having an input port configured to receive the feed signal RF1_{P1}, and (ii) a third hybrid coupler HC3 having first and second “input” ports (ports 4, 1) electrically connected to a pair of output ports of the third wiper-type phase shifter PS3. Moreover, the first array (ARRAY1) is responsive to an RF feed signal RF3_{P1} derived from a first output port of the third phase shifter and hybrid coupler pair 112c, which corresponds to a first output port (port 3) of the third hybrid coupler HC3, whereas the fourth array (ARRAY4) is responsive to an RF feed signal RF3_{P2} derived from a second output port of the third phase shifter and hybrid coupler pair 112c, which corresponds to a second output port (port 2) of the third hybrid coupler HC3.

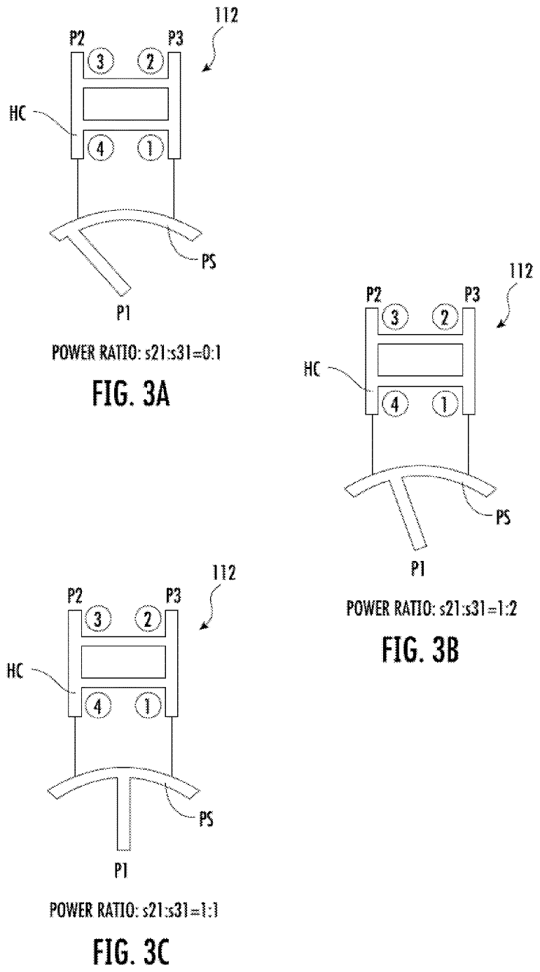

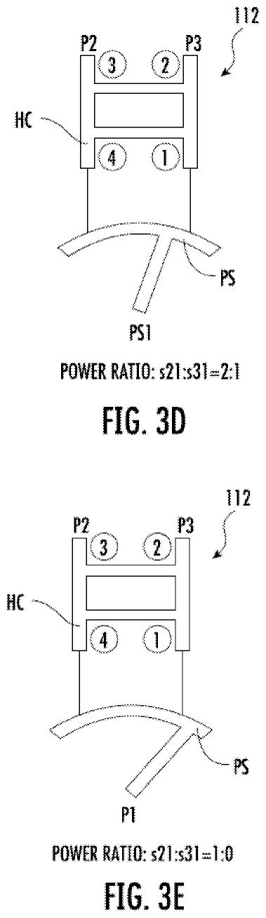

The multi-mode operation of each phase shifter and hybrid coupler pair within the embodiments of FIGS. 2A-2B will now be described with reference to FIGS. 3A-3E, which illustrate five (5) discrete power transfer configurations associated with a single phase shifter and hybrid coupler pair 112 having three ports. These three ports P1, P2, P3 correspond to an input port, a first output port and a second output port, respectively. Now, in FIG. 3A, a first power ratio of 0:1 between the first output port P2 and the second output port P3 can be achieved by adjusting a wiper within the wiper-type phase shifter PS to a first position (e.g., −45°), as shown, such that essentially all of the power associated with an RF feed signal received at the input port P1 is transferred to the second output port P3. And, in FIG. 3B, a second power ratio of 1:2 between the first output port P2 and the second output port P3 can be achieved by adjusting the wiper within the wiper-type phase shifter PS to a second position (e.g., −9.5°), as shown, such that about 33% of the power associated with an RF feed signal received at the input port P1 is transferred to the first output port P2, and about 66% of the power is transferred to the second output port P3. Next, in FIG. 3C, a third power ratio of 1:1 between the first output port P2 and the second output port P3 can be achieved by adjusting the wiper within the wiper-type phase shifter PS to a third position (e.g., 0°), as shown, such that about 50% of the power associated with an RF feed signal received at the input port P1 is transferred to the first output port P2, and about 50% of the power is transferred to the second output port P3. In FIG. 3D, a fourth power ratio of 2:1 between the first output port P2 and the second output port P3 can be achieved by adjusting the wiper within the wiper-type phase shifter PS to a fourth position (e.g., +9.5°), as shown, such that about 66% of the power associated with an RF feed signal received at the input port P1 is transferred to the first output port P2, and about 33% of the power is transferred to the second output port P3. In FIG. 3E, a fifth power ratio of 1:0 between the first output port P2 and the second output port P3 can be achieved by adjusting the wiper within the wiper-type phase shifter PS to a fifth position (e.g., +45°), as shown, such that essentially all of the power associated with an RF feed signal received at the input port P1 is transferred to the first output port P2. Finally, as will be understood by those skilled in the art, these first through fifth settings of the wiper position within the phase shifter PS can be treated as “digital” settings that support discrete and well-defined operating modes of a multi-sector antenna; nonetheless, intermediate “analog” settings of the wiper position may also be used in alternative applications of the multi-sector antenna to thereby achieve varying degrees of asymmetric activity within the antenna sectors.

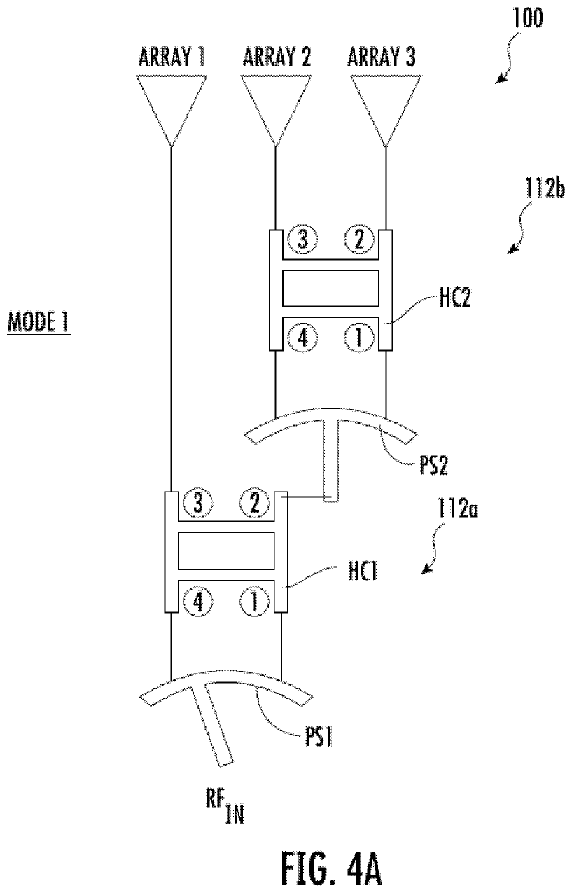

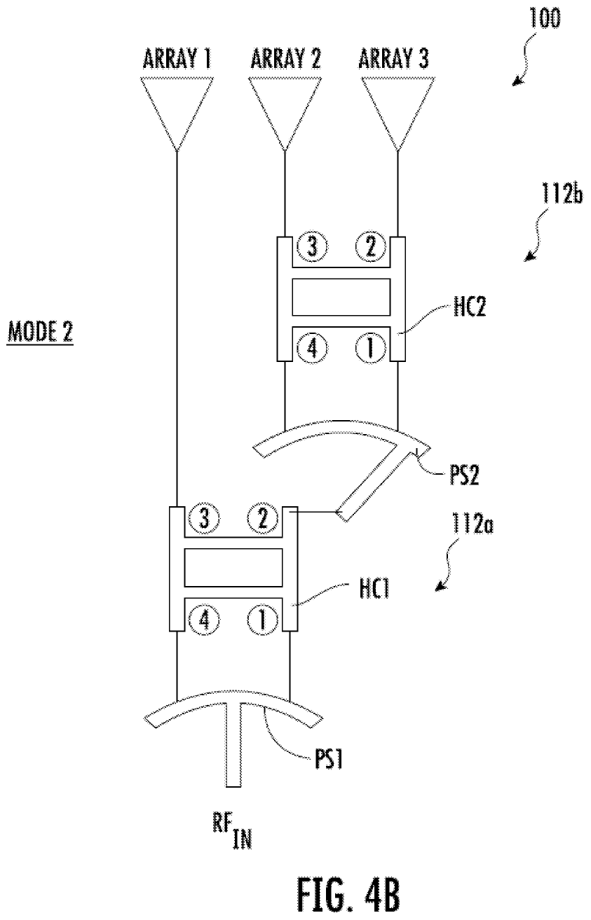

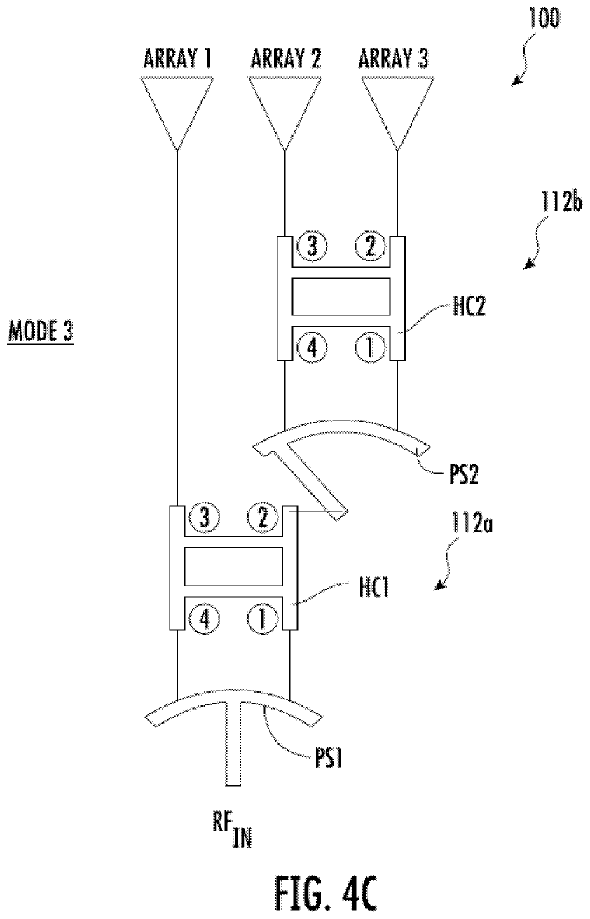

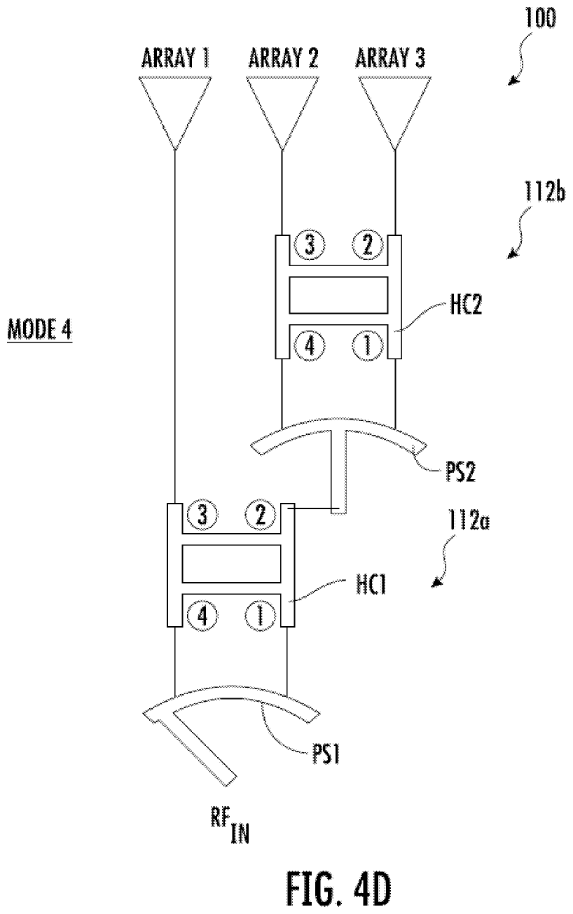

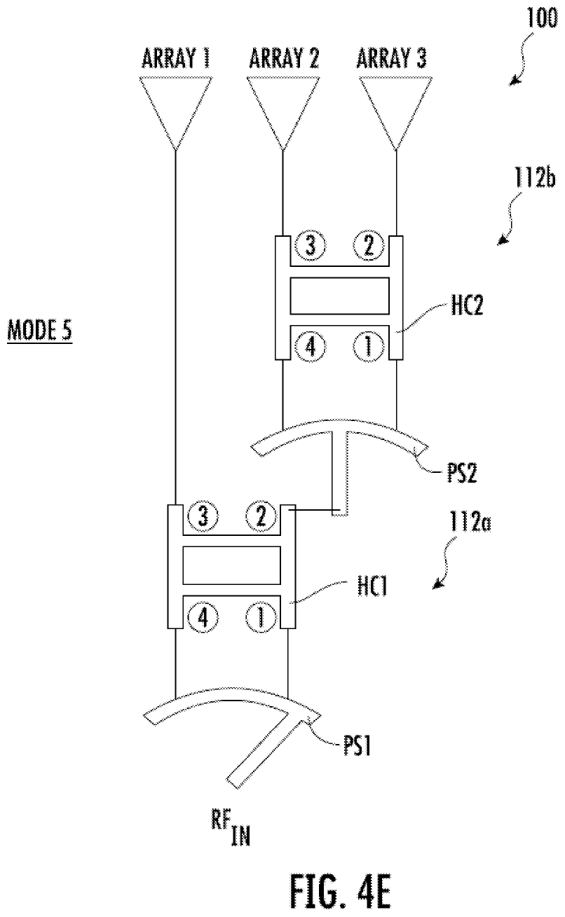

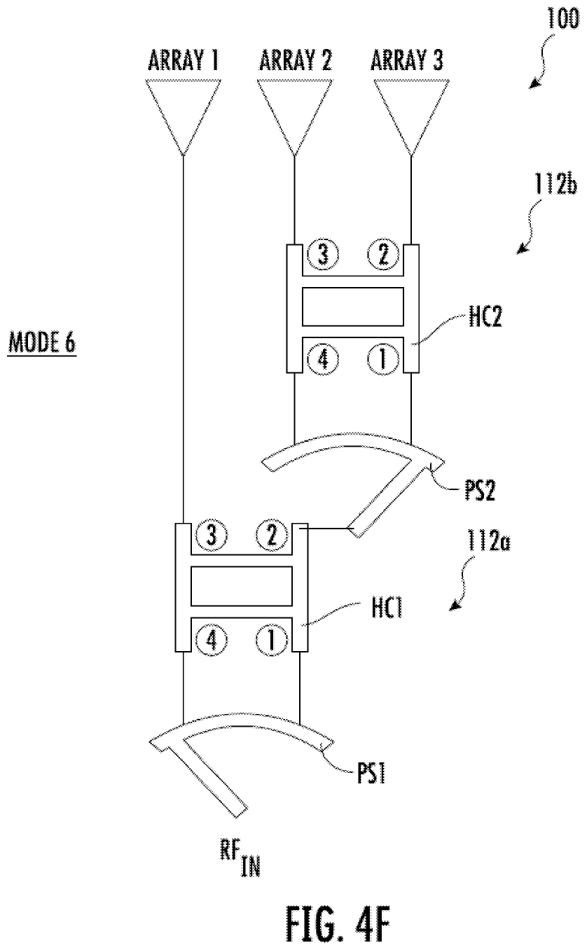

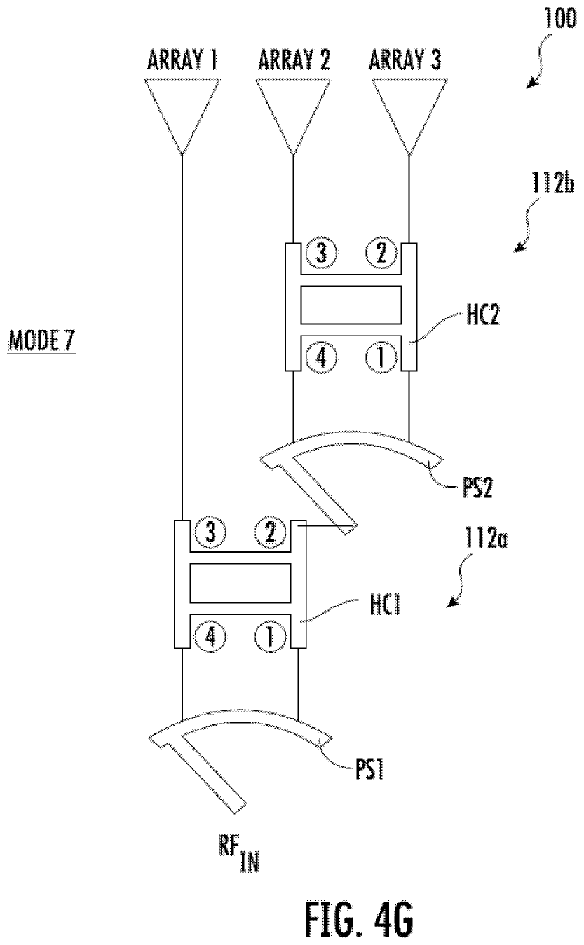

The seven discrete modes of operation of the 3-sector antenna 100 of FIG. 2A will now be described with reference to FIGS. 4A-4G. These seven modes include: Mode 1 with ARRAY1, ARRAY2 and ARRAY3 equally active (i.e., each array receives about ⅓^{rd} of the power from RF_{IN}), as shown by FIG. 4A, Mode 2 with ARRAY1 and ARRAY2 active, ARRAY3 inactive (i.e., the power of RF_{IN} is split about equally between ARRAY1 and ARRAY2), as shown by FIG. 4B, Mode 3 with ARRAY1 and ARRAY3 active, ARRAY2 inactive (i.e., the power of RF_{IN} is split about equally between ARRAY1 and ARRAY3), as shown by FIG. 4C, Mode 4 with ARRAY2 and ARRAY3 active, ARRAY1 inactive (i.e., the power of RF_{IN} is split about equally between ARRAY2 and ARRAY3), as shown by FIG. 4D, Mode 5 with ARRAY1 fully active, ARRAY2 and ARRAY3 inactive, as shown by FIG. 4E, Mode 6 with ARRAY2 fully active, ARRAY1 and ARRAY3 inactive, as shown by FIG. 4F, and Mode 7 with ARRAY3 fully active, ARRAY1 and ARRAY2 inactive, as shown by FIG. 4G.

Moreover, with respect to FIGS. 4A-4G and the five discrete power transfer configurations of FIGS. 3A-3E: Mode 1 can be achieved by setting the first phase shifter PS1 to the second power ratio and the second phase shifter PS2 to the third power ratio; Mode 2 can be achieved by setting the first phase shifter PS1 to the third power ratio and the second phase shifter PS2 to the fifth power ratio; Mode 3 can be achieved by setting the first phase shifter PS1 to the third power ratio and the second phase shifter PS2 to the first power ratio; Mode 4 can be achieved by setting the first phase shifter PS1 to the first power ratio and the second phase shifter PS2 to the third power ratio; Mode 5 can be achieved by setting the first phase shifter PS1 to the fifth power ratio and the second phase shifter PS2 to the third power ratio; Mode 6 can be achieved by setting the first phase shifter PS1 to the first power ratio and the second phase shifter PS2 to the fifth power ratio; and Mode 7 can be achieved by setting the first phase shifter PS1 to the first power ratio and the second phase shifter PS2 to the first power ratio. These configurations are summarized below by Table 1.

TABLE 1

| | Work State | 1^{st} Phase Shifter | 2^{nd} Phase Shifter | 1^{st} Phase Shifter | 2^{nd} Phase Shifter |
|---|---|---|---|---|---|
| Mode | (active) | Wiper Position | Wiper Position | Power Ratio | Power Ratio |
| 1 | ARRAY1-ARRAY3 | −9.5° | 0° | 1:2 | 1:1 |
| 2 | ARRAY1, ARRAY2 | 0° | +45° | 1:1 | 1:0 |
| 3 | ARRAY1, ARRAY3 | 0° | −45° | 1:1 | 0:1 |
| 4 | ARRAY2, ARRAY3 | −45° | 0° | 0:1 | 1:1 |
| 5 | ARRAY1 | +45° | 0° | 1:0 | 1:1 |
| 6 | ARRAY2 | −45° | +45° | 0:1 | 1:0 |
| 7 | ARRAY3 | −45° | −45° | 0:1 | 0:1 |

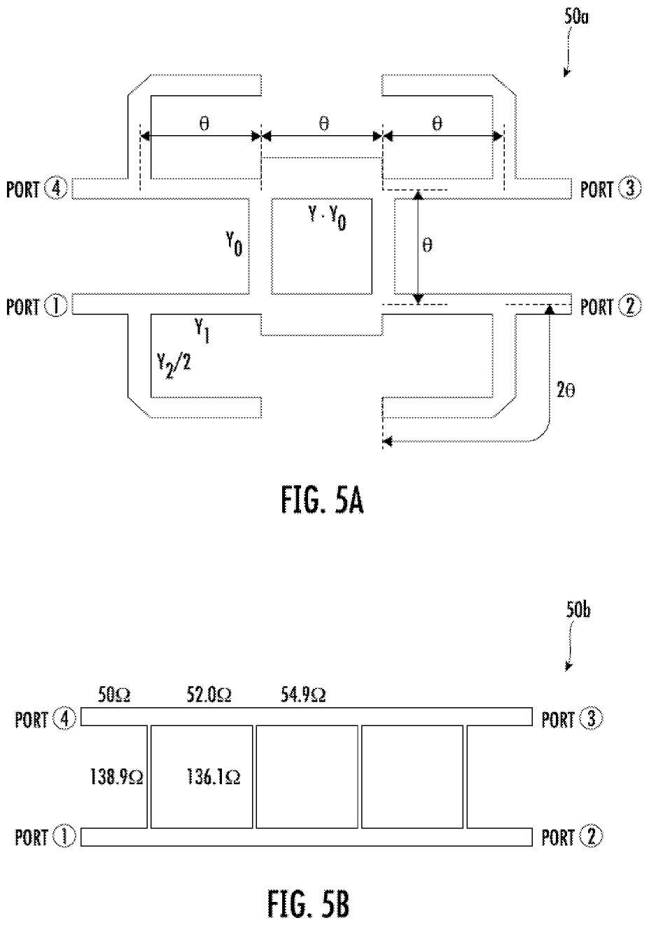

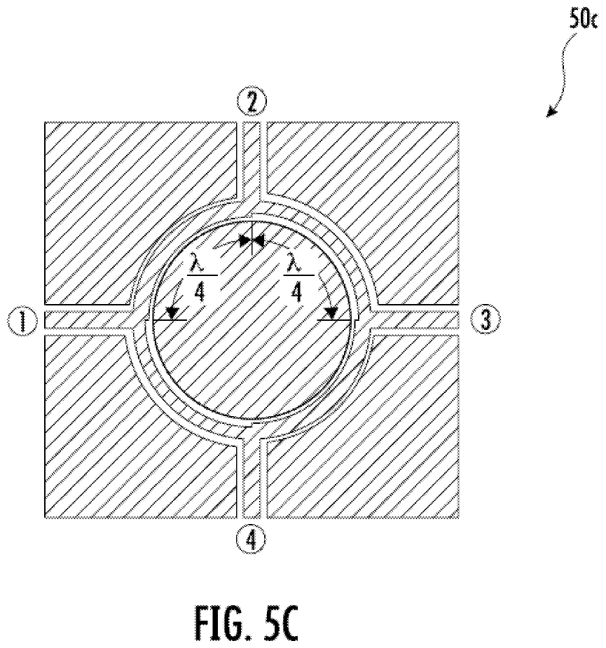

Although not wishing to be bound by any theory, the above-described antenna work states associated with Modes 1-7 generally assume ideal RF signal characteristics associated with each phase shifter and hybrid coupler in the cascaded arrangement. Nonetheless, because of potential bandwidth limitations associated with conventional hybrid couplers, insufficient inhibition of RF signals at one or more output ports of the couplers HC1, HC2 may result in some limited degree of RF power being provided to an array(s) having an inactive work state, which may adversely impact a front-to-back (F/B) ratio of the multi-sector antenna described herein. Fortunately, as illustrated by FIGS. 5A-5C, hybrid couplers having wider bandwidths may be utilized within the above-described feed networks. These hybrid couplers include a parallel λ/2 open branch coupler 50a, as shown by FIG. 5A, a multi-segment hybrid coupler 50b, as shown by FIG. 5B, and a coplanar waveguide (CPW) circle hybrid coupler 50c, as shown by FIG. 5C.

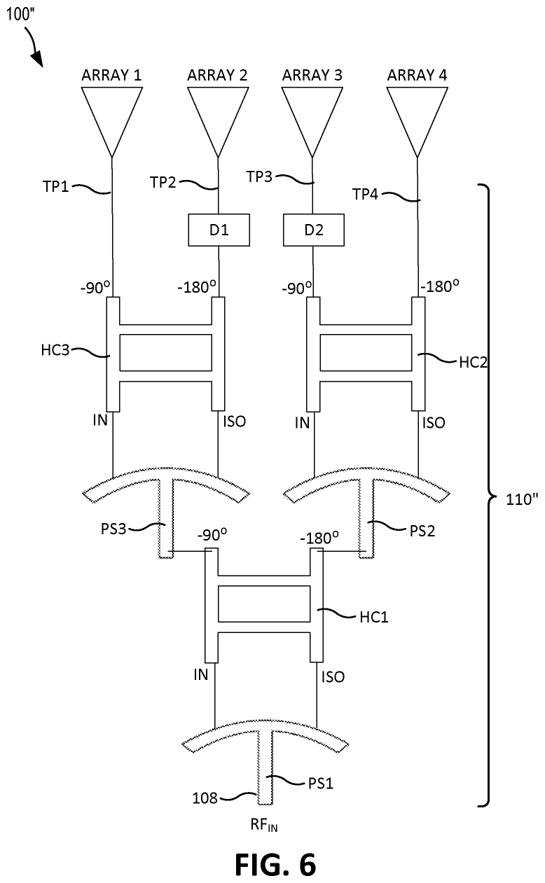

FIG. 6 is a block diagram of a multi-mode 4-sector antenna 100″ according to further embodiments of the invention. The multi-mode 4-sector antenna 100″ includes an RF input port 108, a feed network 110″ and four antenna arrays ARRAY1 through ARRAY 4. Each antenna array 1 through ARRAY 4 may include one or more radiation elements (e.g., dual-polarized cross-dipole radiating elements). Typically, each antenna array ARRAY1 through ARRAY 4 will have the same design, configuration ad number of radiating elements. In some embodiments, each antenna array ARRAY1 through ARRAY 4 may comprise a single radiating element or a vertically-extending column of between two and six radiating elements. Such vertically-extending columns of radiating elements may be referred to herein as “linear arrays” of radiating elements.

The multi-mode 4-sector antenna 100″ of FIG. 6 may be similar to the multi-mode 4-sector antenna 100′ of FIG. 2B, but the feed network 110″ of multi-mode 4-sector antenna 100″ further includes first and second fixed delay elements D1 and D2. As shown in FIG. 6, the first delay element D1 is coupled to the first output (the −90° output) of the second hybrid coupler HC2 and the second delay element D2 is coupled to the second output (the −180° output) of the third hybrid coupler HC3. Each delay element D1, D2 may, for example, be configured to impart a delay of about 180° for RF signals that are at a center frequency of the operating frequency band of multi-mode 4-sector antenna 100″. The delay elements D1, D2 may, for example, comprise RF transmission line segments that will impart the necessary additional delay. For example, if the outputs of the second and third hybrid couplers HC2, HC3 are connected to the respective antenna arrays ARRAY 1 through ARRAY 4 via coaxial cables, the coaxial cable connecting the first output of the second hybrid coupler HC2 to the third antenna array 3 and the coaxial cable connecting the second output of the third hybrid coupler HC3 to the second antenna array 2 may be lengthened as compared to the coaxial cable connecting the second output of the second hybrid coupler HC2 to the fourth antenna array 4 and the coaxial cable connecting the first output of the third hybrid coupler HC3 to the first antenna array 1. The provision of the delay elements D1, D2 may improve the shape of the antenna beam when the multi-mode 4-sector antenna 100″ is configured to operate in an omnidirectional mode of operation.

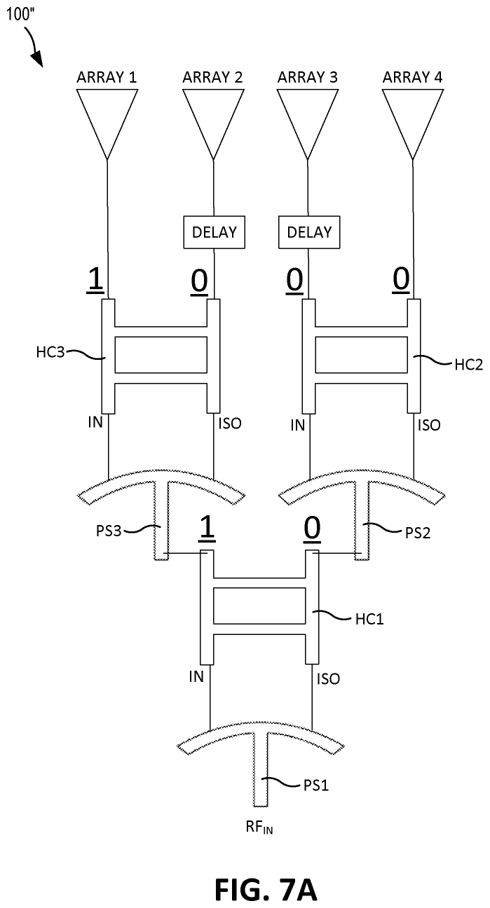

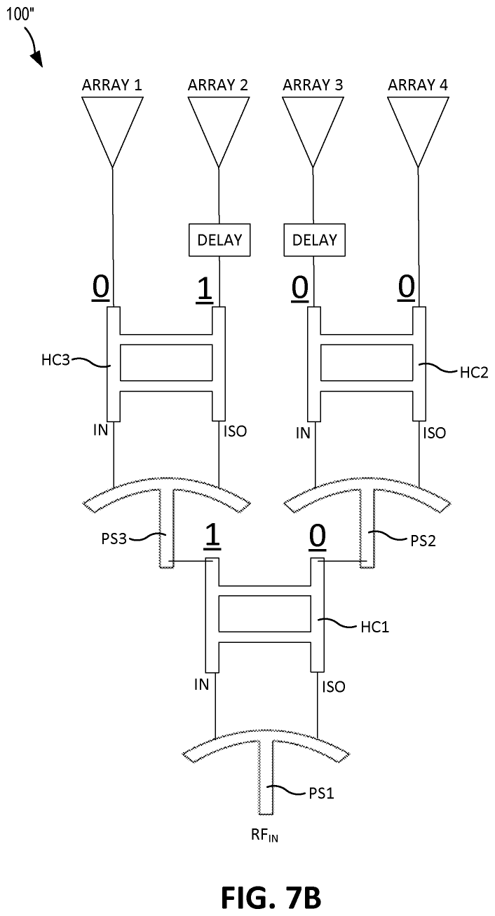

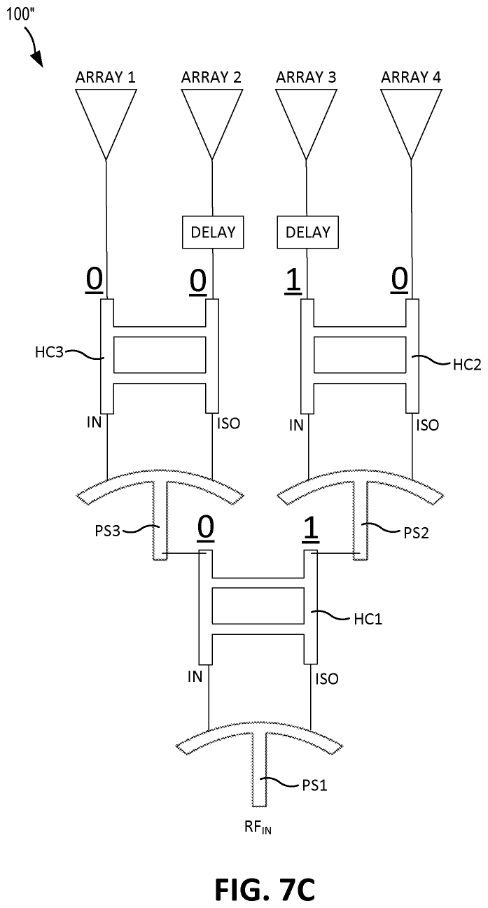

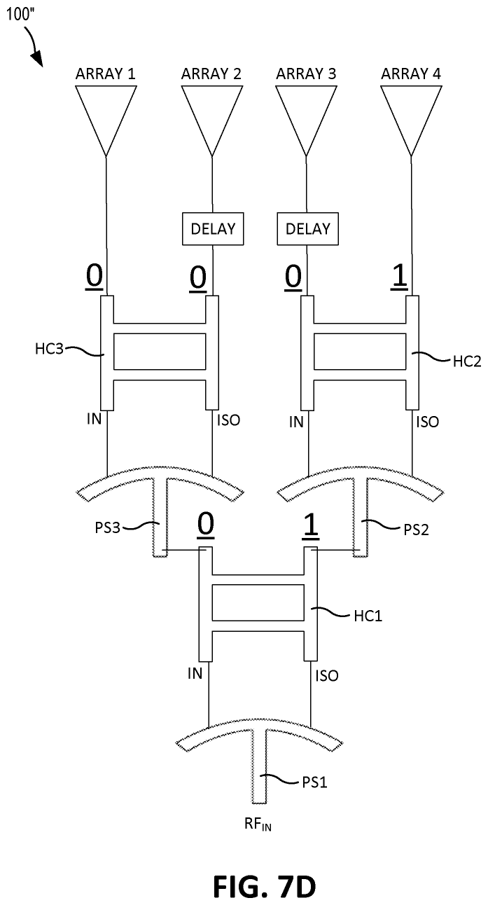

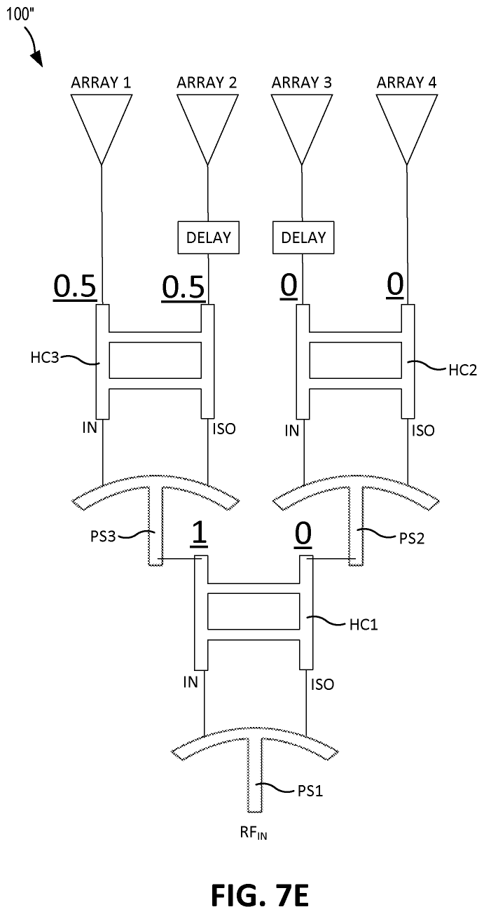

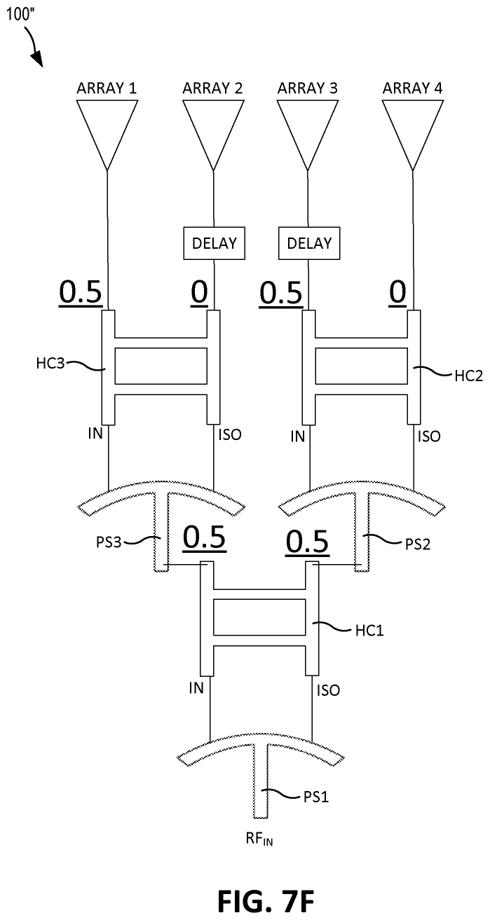

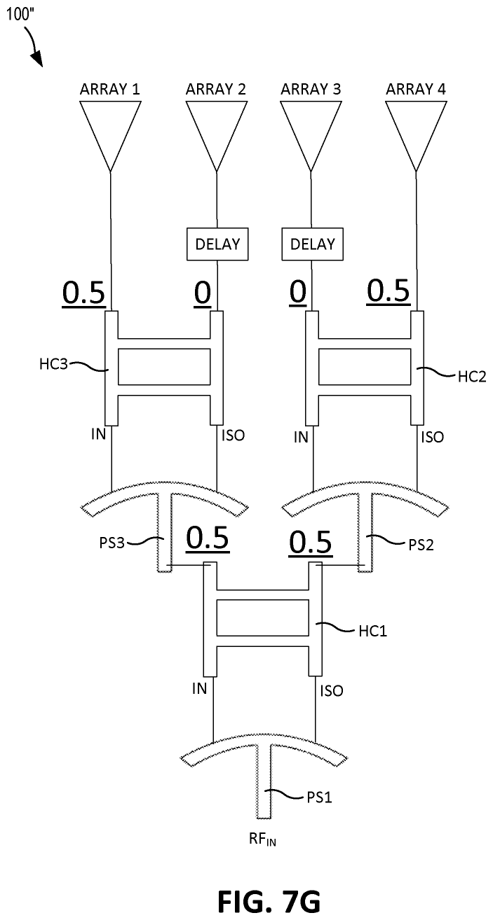

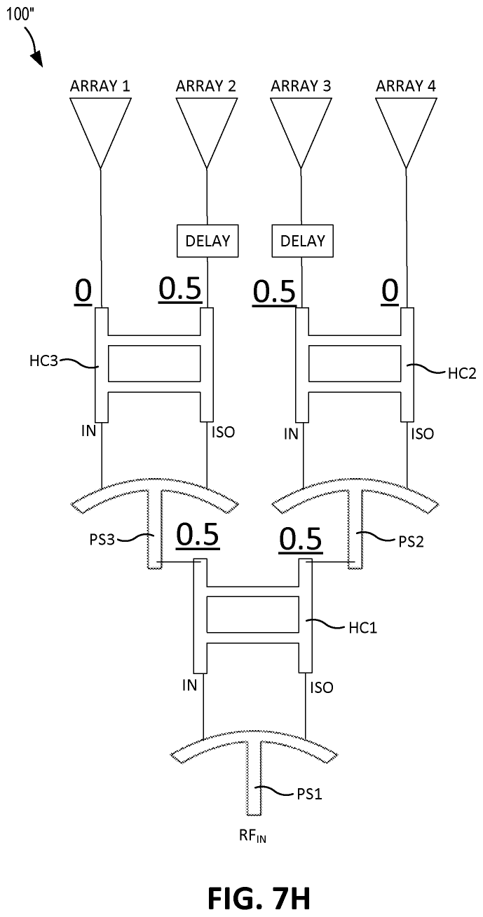

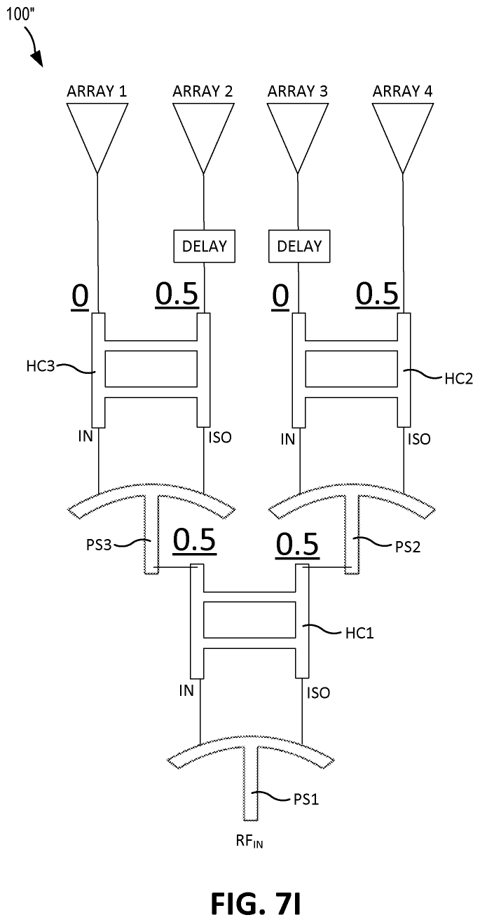

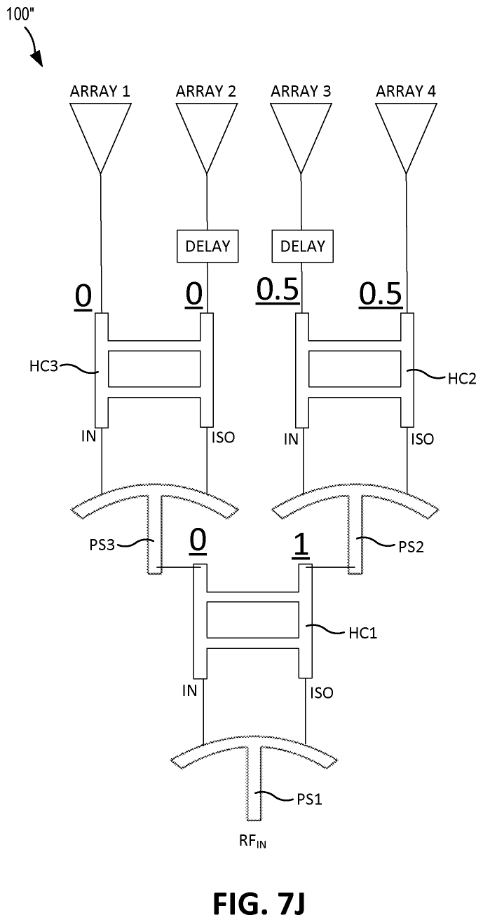

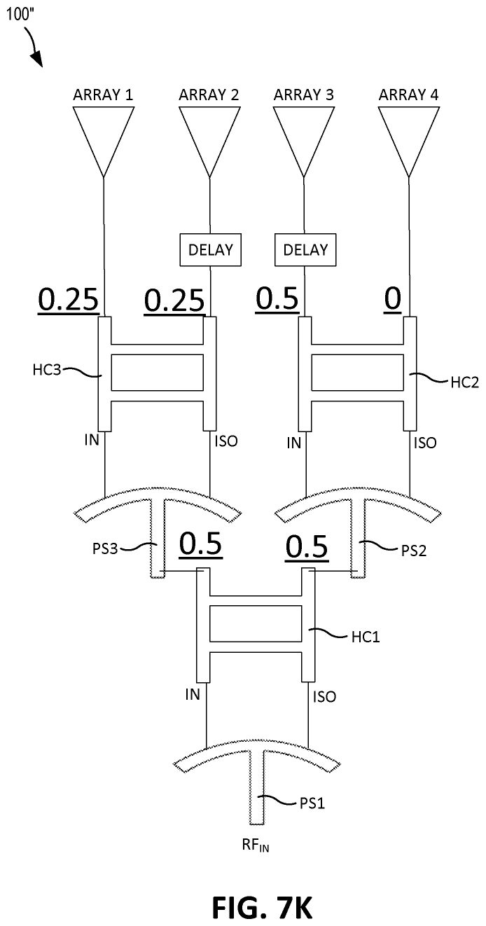

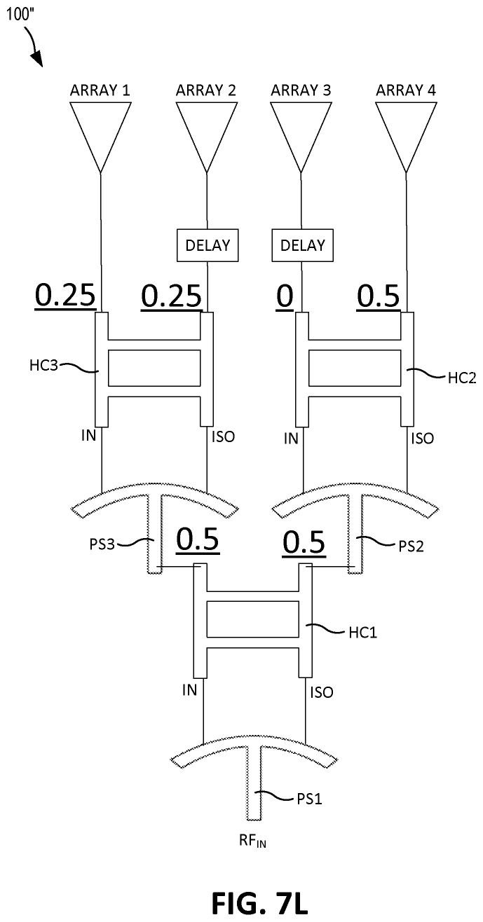

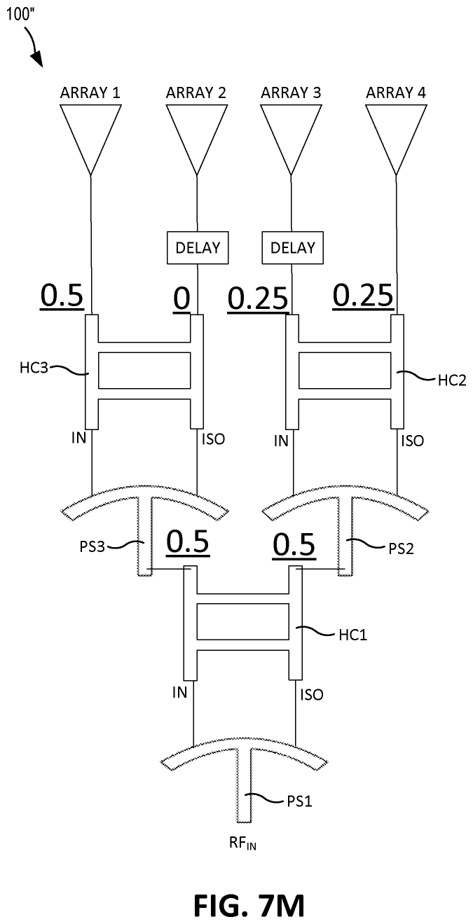

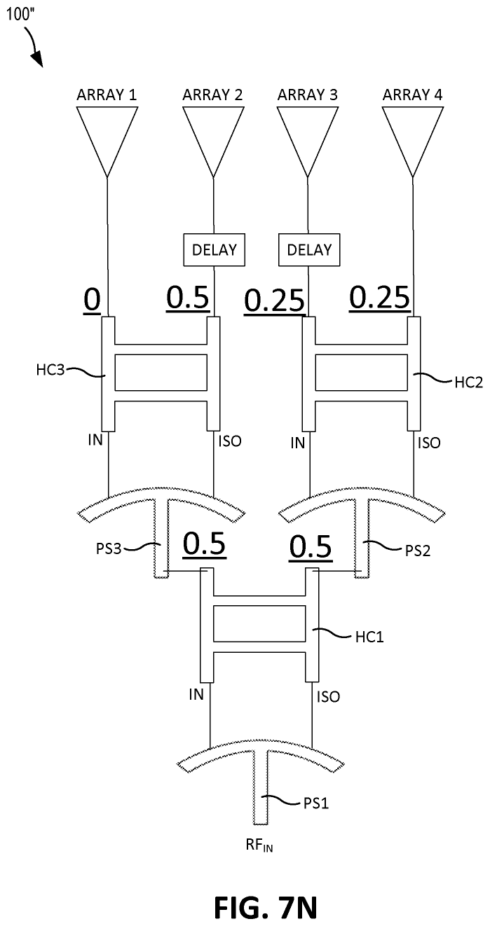

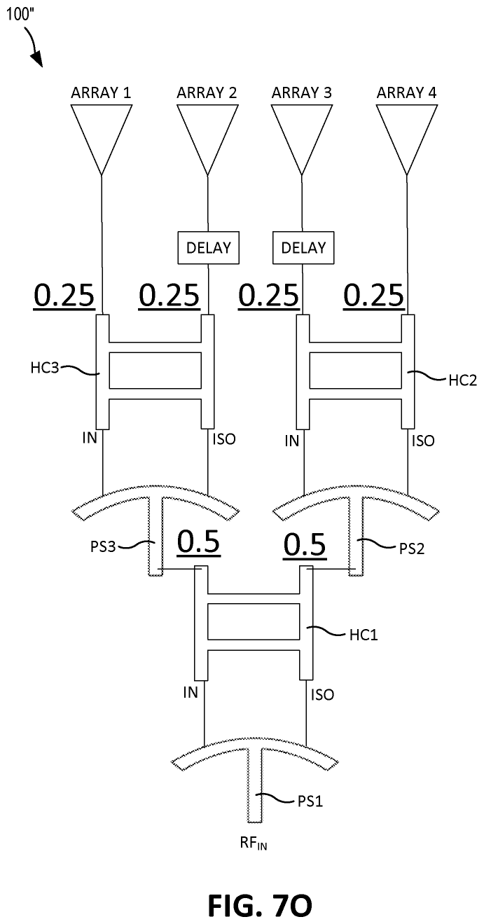

FIGS. 7A-7O are diagrams schematically illustrating the fifteen operating modes of the multi-mode 4-sector antenna of FIG. 6. In FIGS. 7A-7O the actual wiper positions of the wiper-type phase shifters PS1 through PS3 that cause the antenna to operate in a given mode are not shown in the drawings for simplicity, and instead the percentage of the power input to each hybrid coupler HC1 through HC3 that is output through the first and second outputs of each hybrid coupler HC1 through HC3 are shown by the large numbers included in each figure adjacent the first and second outputs of each hybrid coupler HC1 through HC3. When the number “1” is provided adjacent an output port of one of the hybrid couplers HC1 through HC3, it indicates that substantially all of the power input to the hybrid coupler is output through that output port. When number “0” is provided adjacent an output port of one of the hybrid couplers HC1 through HC3, it indicates that substantially none of the power input to the hybrid coupler is output through that output port. Similarly, the numbers “0.5” and “0.25” indicate, respectively, that about half and about one quarter of the power input to the hybrid coupler is output through the output port. It will be appreciated that hybrid couplers have associated insertion losses, such that some amount of the power input to an input port of a hybrid coupler will not be output through either output port of the hybrid coupler, but instead will, for example, be output through the isolation port, reflected back through the input port or radiated from the RF transmission lines within the hybrid coupler. It will be appreciated that the above references to the amount of power output through the first and second output ports of a hybrid coupler as a percentage of the amount of power input to the hybrid coupler ignore the above-discussed insertion losses. The same is true with respect to other components of the feed networks for the antennas according to embodiments of the present invention, such as phase shifters, RF transmission line components, delay elements and the like. Thus, it will be appreciated that in the description and claims of this application, references to the percentage of power of an RF input signal that is input to a circuit element (e.g., a hybrid coupler, a phase shifter, a feed network, etc.) that is output at a port of the circuit element ignores these insertion losses. FIGS. 7A-7O illustrate the percentage of the power of an RF input signal that is input at RF input port 108 that is present at the outputs of each of the three hybrid couplers HC1 through HC3 (with insertion losses ignored) when the antenna of FIG. 6 is operated in each of its respective fifteen operating modes.

As shown in FIG. 7A, in a first operating mode, substantially all of the RF power of RF input signal RF_{IN} that is input to the feed network 110″ is output to the first antenna array ARRAY 1 (ignoring insertion losses of the hybrid couplers HC1 through HC3 and the phase shifters PS1 through PS3 and any intervening RF transmission lines). To accomplish this, the first and third phase shifters PS1, PS3 may be set as shown in FIG. 3E and the second phase shifter PS2 may be set to any position (as substantially no power is passed to the second phase shifter).

As shown in FIG. 7B, in a second operating mode, substantially all of the RF power of RF input signal RF_{IN} that is input to the feed network 110″ is output to the second antenna array ARRAY 2 (again ignoring all insertion losses in the feed network). To accomplish this, the first phase shifter PS1 may be set as shown in FIG. 3E, the third phase shifter PS3 may be set as shown in FIG. 3A, and the second phase shifter PS2 may be set to any position.

As shown in FIG. 7C, in a third operating mode, substantially all of the RF power of RF input signal RF_{IN} that is input to the feed network 110″ is output to the third antenna array ARRAY 3 (again ignoring all insertion losses in the feed network). To accomplish this, the first phase shifter PS1 may be set as shown in FIG. 3A, the second phase shifter PS2 may be set as shown in FIG. 3E, and the third phase shifter PS3 may be set to any position.

As shown in FIG. 7D, in a fourth operating mode, substantially all of the RF power of RF input signal RF_{IN} that is input to the feed network 110″ is output to the fourth antenna array ARRAY 4 (again ignoring all insertion losses in the feed network). To accomplish this, the first and second phase shifters PS1, PS2 may be set as shown in FIG. 3A, and the third phase shifter PS3 may be set to any position.

In each of the first through fourth operating modes discussed above with respect to FIGS. 7A-7D, the multi-mode 4-sector antenna 100″ will operate as a single sector antenna, generating antenna beams that are, for example, designed to cover a single sector that extends for 90° in the azimuth plane. The four antenna arrays ARRAY 1 through ARRAY 4 may, for example, be mounted to face outwardly from the four sides of an antenna mounting structure that has a rectangular cross-section. The above-discussed first through fourth operating modes allow the antenna 100″ to be set to pass substantially all of the RF energy of an RF signal that is input to the antenna 100″ to one of the four antenna arrays ARRAY 1 through ARRAY 4. Thus, in these four modes, the antenna 100″ acts as a sector antenna, with the only difference being which of the four sectors in the azimuth plane is illuminated by the antenna beam.

FIGS. 7E-7J illustrate operating modes in which multi-mode 4-sector antenna 100″ splits the power of an RF signal input to the antenna 100″ between two of the four antenna arrays ARRAY 1 through ARRAY 4.

As shown in FIG. 7E, in a fifth operating mode, about half of the RF power of an RF input signal RF_{IN} that is input to the feed network 110″ is output to the first antenna array ARRAY 1 and the other half of the RF power of the RF input signal RF_{IN} is output to the second antenna array ARRAY 2 (again ignoring all insertion losses in the feed network). To accomplish this, the first phase shifter PS1 is set as shown in FIG. 3E, the third phase shifter PS3 is set as shown in FIG. 3C and the second phase shifter PS2 may be set to any position.

As shown in FIG. 7F, in a sixth operating mode, about half of the RF power of an RF input signal RF_{IN} that is input to the feed network 110″ is output to the first antenna array ARRAY 1 and the other half of the RF power of the RF input signal RF_{IN} is output to the third antenna array ARRAY 3 (again ignoring all insertion losses in the feed network). To accomplish this, the first phase shifter PS1 is set as shown in FIG. 3C and the second and third phase shifters PS2, PS3 are set as shown in FIG. 3E.

As shown in FIG. 7G, in a seventh operating mode, about half of the RF power of an RF input signal RF_{IN} that is input to the feed network 110″ is output to the first antenna array ARRAY 1 and the other half of the RF power of the RF input signal RF_{IN} is output to the fourth antenna array ARRAY 4 (again ignoring all insertion losses in the feed network). To accomplish this, the first phase shifter PS1 is set as shown in FIG. 3C, the second phase shifter PS2 is set as shown in FIG. 3A, and the third phase shifter PS3 is set as shown in FIG. 3E.

As shown in FIG. 7H, in an eighth operating mode, about half of the RF power of an RF input signal RF_{IN} that is input to the feed network 110″ is output to the second antenna array ARRAY 2 and the other half of the RF power of the RF input signal RF_{IN} is output to the third antenna array ARRAY 3 (again ignoring all insertion losses in the feed network). To accomplish this, the first phase shifter PS1 is set as shown in FIG. 3C, the second phase shifter PS2 is set as shown in FIG. 3E, and the third phase shifter PS3 is set as shown in FIG. 3A.

As shown in FIG. 7I, in a ninth operating mode, about half of the RF power of an RF input signal RF_{IN} that is input to the feed network 110″ is output to the second antenna array ARRAY 2 and the other half of the RF power of the RF input signal RF_{IN} is output to the fourth antenna array ARRAY 4 (again ignoring all insertion losses in the feed network). To accomplish this, the first phase shifter PS1 is set as shown in FIG. 3C, and the second and third phase shifters PS2, PS3 are set as shown in FIG. 3A.

As shown in FIG. 7J, in a tenth operating mode, about half of the RF power of an RF input signal RF_{IN} that is input to the feed network 110″ is output to the second antenna array ARRAY 2 and the other half of the RF power of the RF input signal RF_{IN} is output to the third antenna array ARRAY 3 (again ignoring all insertion losses in the feed network). To accomplish this, the first phase shifter PS1 is set as shown in FIG. 3A, the second phase shifter PS2 is set as shown in FIG. 3C, and the third phase shifter PS3 may be set to any position.

FIGS. 7K-7N illustrate operating modes in which multi-mode 4-sector antenna 100″ splits the power of an RF signal input to the antenna 100″ between three of the four antenna arrays ARRAY 1 through ARRAY 4.

As shown in FIG. 7K, in an eleventh operating mode, about half of the RF power of an RF input signal RF_{IN} that is input to the feed network 110″ is output to the third antenna array ARRAY 3, about one quarter of the RF power of the RF input signal RF_{IN} is output to the first antenna array ARRAY 1, and about one quarter of the RF power of the RF input signal RF_{IN} is output to the second antenna array ARRAY 2 (again ignoring all insertion losses in the feed network). To accomplish this, the first and third phase shifters PS1, PS3 are set as shown in FIG. 3C, and the second phase shifter PS2 is set as shown in FIG. 3E.

As shown in FIG. 7L, in a twelfth operating mode, about half of the RF power of an RF input signal RF_{IN} that is input to the feed network 110″ is output to the fourth antenna array ARRAY 4, about one quarter of the RF power of the RF input signal RF_{IN} is output to the first antenna array ARRAY 1, and about one quarter of the RF power of the RF input signal RF_{IN} is output to the second antenna array ARRAY 2 (again ignoring all insertion losses in the feed network). To accomplish this, the first and third phase shifters PS1, PS3 are set as shown in FIG. 3C, and the second phase shifter PS2 is set as shown in FIG. 3A.

As shown in FIG. 7M, in a thirteenth operating mode, about half of the RF power of an RF input signal RF_{IN} that is input to the feed network 110″ is output to the first antenna array ARRAY 1, about one quarter of the RF power of the RF input signal RF_{IN} is output to the third antenna array ARRAY 3, and about one quarter of the RF power of the RF input signal RF_{IN} is output to the fourth antenna array ARRAY 4 (again ignoring all insertion losses in the feed network). To accomplish this, the first and second phase shifters PS1, PS2 are set as shown in FIG. 3C, and the third phase shifter PS3 is set as shown in FIG. 3E.

As shown in FIG. 7N, in a fourteenth operating mode, about half of the RF power of an RF input signal RF_{IN} that is input to the feed network 110″ is output to the second antenna array ARRAY 2, about one quarter of the RF power of the RF input signal RF_{IN} is output to the third antenna array ARRAY 3, and about one quarter of the RF power of the RF input signal RF_{IN} is output to the fourth antenna array ARRAY 4 (again ignoring all insertion losses in the feed network). To accomplish this, the first and second phase shifters PS1, PS2 are set as shown in FIG. 3C, and the third phase shifter PS3 is set as shown in FIG. 3A.

As shown in FIG. 7O, multi-mode 4-sector antenna 100″ may also operate in a fifteenth “omnidirectional” (in the azimuth plane) mode in which the power of an RF signal input to the antenna 100″ is split equally between all four of the antenna arrays ARRAY 1 through ARRAY 4 (again ignoring all insertion losses in the feed network). To accomplish this, the first through third phase shifters PS1, PS2, PS3 are all set as shown in FIG. 3C.

Referring to FIGS. 6-7O, pursuant to some embodiments of the present invention, a multi-mode base station antenna 100″ is provided that comprises a first RF signal input 108 and first through fourth antenna arrays ARRAY 1 through ARRAY 4. The multi-mode base station antenna 100″ further comprises a feed network 110″ that connects the first RF signal input 108 to the first through fourth antenna arrays ARRAY 1 through ARRAY 4. The feed network 110″ comprises a plurality of hybrid couplers HC1 through HC3 and a plurality of adjustable phase shifters PS1 through PS3. The adjustable phase shifters PS1 through PS3 are configurable so that antenna 100″ can operate in a plurality of different operating modes. For example, the first through third adjustable phase shifters PS1 through PS3 may be set to route substantially all of the power of an RF signal input at the first RF signal input 108 to a selected one of any of the first through fourth antenna arrays ARRAY 1 through ARRAY 4 or to split the power equally between all four of the first through fourth antenna arrays ARRAY 1 through ARRAY 4. In other words, the first through third adjustable phase shifters PS1 through PS3 may be set to any one of at least five different operating modes (i.e., the operating modes illustrated in FIGS. 7A-7D and 7O).

In some embodiments, the adjustable phase shifters PS1 through PS3 may be further configurable to route substantially all of the power of the RF signal input at the first RF signal input 108 to any combination of two of the first through fourth antenna arrays ARRAY 1 through ARRAY 4 or to any combination of three of the first through fourth antenna arrays ARRAY 1 through ARRAY 4. In these embodiments, the first through third adjustable phase shifters PS1 through PS3 may be set to any one of an additional ten different operating modes (i.e., the operating modes illustrated in FIGS. 7E-7N).

In some embodiments, the mechanically adjustable phase shifters PS1 through PS3 may be wiper-type phase shifters.

In some embodiments, the plurality of hybrid couplers comprises first through third hybrid couplers HC1 through HC3 that each have first and second input ports and first and second output ports, where the first hybrid coupler HC1 is on an electrical path between the first RF signal input 108 and the second and third hybrid couplers HC2, HC3, and the first output port of the second hybrid coupler HC2 is coupled to the first antenna array ARRAY 1, the second output port of the second hybrid coupler HC2 is coupled to the second antenna array ARRAY 2, the first output port of the third hybrid coupler HC3 is coupled to the third antenna array ARRAY 3, and the second output port of the third hybrid coupler HC3 is coupled to the fourth antenna array ARRAY 4.

In some embodiments, a first electrical length of a first transmission path TP1 between the first output port of the second hybrid coupler HC2 and the first antenna array ARRAY 1 is different than a second electrical length of a second transmission path TP2 between the second output port of the second hybrid coupler HC2 and the second antenna array ARRAY 2. In addition, a third electrical length of a third transmission path TP3 between the first output port of the third hybrid coupler HC3 and the third antenna array ARRAY 3 is different than a fourth electrical length of a fourth transmission path TP4 between the second output port of the third hybrid coupler HC3 and the fourth antenna array ARRAY 4. In some embodiments, the first electrical length may be equal to the fourth electrical length and/or the second electrical length may be equal to the third electrical length.

Still referring to FIGS. 6-7O, pursuant to further embodiments of the present invention, a multi-mode base station antenna 100″ is provided that comprises a first RF signal input 108 and first through fourth antenna arrays ARRAY 1 through ARRAY 4. The multi-mode base station antenna 100″ further comprises a feed network 110″ that connects the first RF signal input 108 to the first through fourth antenna arrays ARRAY 1 through ARRAY 4. The feed network 110″ comprises a second hybrid coupler HC2 that has a first output that is connected to the first antenna array ARRAY 1 and a second output that is connected to the second antenna array ARRAY 2, a third hybrid coupler HC3 that has a first output that is connected to the third antenna array ARRAY 3 and a second output that is connected to the fourth antenna array ARRAY 4, and a first fixed delay element D1 that is provided along a second transmission path TP2 between the second output port of the first hybrid coupler HC2 and the second antenna array ARRAY 2. The first fixed delay element D1 may be configured to ensure that a first electrical length of a first transmission path TP1 between the first output port of the first hybrid coupler HC2 and the first antenna array ARRAY 1 is less than a second electrical length of the second transmission path TP2.

The multi-mode antenna 100″ may further include a second fixed delay element D2 that is provided along a third transmission path TP3 between the first output port of the third hybrid coupler HC3 and the third antenna array ARRAY 3 that is configured to ensure that a fourth electrical length of a fourth transmission path TP4 between the second output port of the third hybrid coupler HC3 and the fourth antenna array ARRAY 4 is less than a third electrical length of the third transmission path TP3. In some embodiments, the first electrical length may be equal to the fourth electrical length and/or the second electrical length may be equal to the third electrical length.

In some embodiments, the feed network 110″ may further comprise a first hybrid coupler HC1 and a first adjustable phase shifter PS1 that is coupled between the first RF signal input 108 and the first and second inputs of the first hybrid coupler HC1, where a first output of the first hybrid coupler HC1 is coupled to first and second inputs of the second hybrid coupler HC2 through a second adjustable phase shifter PS2, and a second output of the first hybrid coupler HC1 is coupled to first and second inputs of the third hybrid coupler HC3 through a third adjustable phase shifter PS3.

In some embodiments, the first through third adjustable phase shifters PS1 through PS3 may be configurable to route substantially all of the power of an RF signal input at the first RF signal input 108 to a selected one of any of the first through fourth antenna arrays ARRAY 1 through ARRAY 4 or to split the power of the RF signal input at the first RF signal input 108 equally between all four of the first through fourth antenna arrays ARRAY 1 through ARRAY 4. In addition, the first through third adjustable phase shifters PS1 through PS3 may be further configurable to route substantially all of the power of the RF signal input at the first RF signal input 108 to any combination of two of the first through fourth antenna arrays ARRAY 1 through ARRAY 4 or to any combination of three of the first through fourth antenna arrays ARRAY 1 through ARRAY 4.

In some embodiments, the first through third adjustable phase shifters PS1 through PS3 may be mechanically adjustable wiper-type phase shifters.

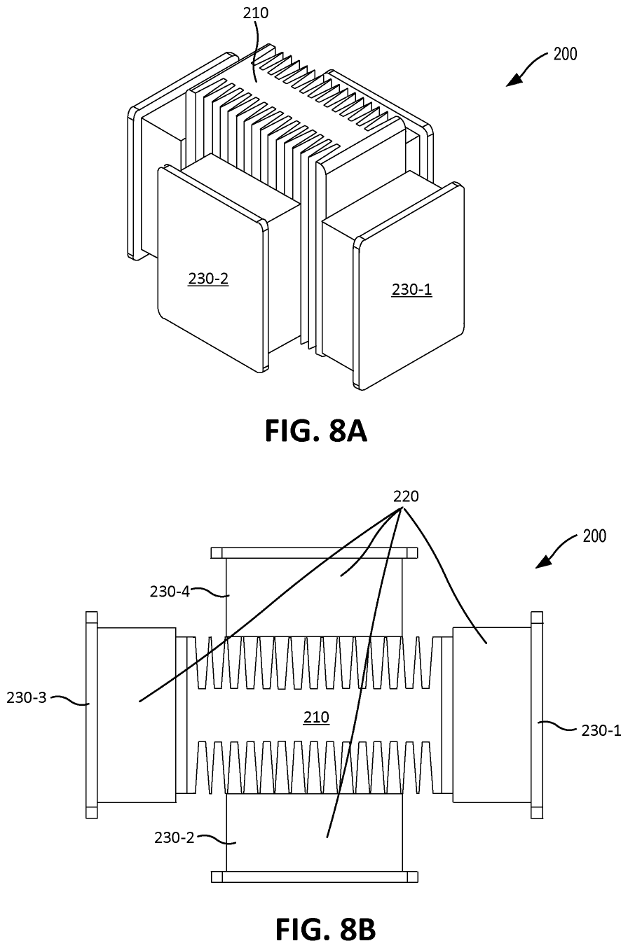

FIG. 8A is a schematic perspective view of a base station 200 according to embodiments of the present invention. FIG. 8B is a schematic top view of the base station 200 of FIG. 8A. Base station 200 may be used, for example, as a strand mounted base station.

Strand mount base stations and antennas refer to base stations/antennas that are designed to be mounted on high-strength wires that are referred to as “strands” that are strung between telecommunication poles. Communications cables (e.g., fiber optic cables and coaxial cables) are supported on the strands and strung between the poles. The poles, cables and strands are typically owned by cable television network operators. Some of these cable television network operators also now operate as mobile virtual network operators. A mobile virtual network operator refers to a cellular communications provider that primarily or exclusively leases cellular capacity from mobile network operators who own and operate extensive cellular networks. A cable television network operator may configure subscriber devices to automatically connect to a WiFi network in the subscriber premise, and thus the cable television network operator can act as a mobile virtual network operator to provide “cellular” service to subscribers within their homes without any need to lease cellular resources from mobile network operators. When the subscribers leave their homes/premises, the WiFi connection is lost and a cable television network operator that also operates as a mobile virtual network operator then would typically have to lease cellular services from a mobile network operator. To reduce such leasing costs, cable television network operators are deploying outdoor WiFi access points and CBRS base stations that can provide connectivity for subscribers outside of their premises, thereby reducing the amount of cellular resources that they need to lease from true mobile network operators. Pole-mounted strands have turned out to be a convenient location for cable television network operators who also operate as mobile virtual network operators to mount WiFi access points and/or CBRS base stations (which are collectively referred to herein using the generic term “base station”). As noted above, the cable television network operator owns the strands, and hence by strand-mounting the base stations the operator may avoid the need to lease mounting locations, which can be time consuming and expensive (due to the large number of base stations and the administrative burden of negotiating leases). Additionally, many strands carry coaxial cables which can carry sufficient power to operate a WiFi access point or CBRS base station. Moreover, the strands are typically elevated about 20-30 feet above the ground, which improves the coverage provided by each base station.

As shown in FIGS. 8A-8B, base station 200 (e.g., a WiFi access point or CBRS base station) includes a radio unit 210 and a base station antenna 220 that includes four antenna units 230-1 through 230-4. Each antenna unit 230 may be mounted on a respective one of the four sides of the radio unit 210. The radio unit 210 may, for example, include one or more radios, where the radios may operate, for example, in one or more of the WiFi frequency bands or in the CBRS frequency band. Currently, most WiFi networks support communications in the 2.401-2.484 GHz and 5.170-5.835 GHz frequency ranges, which are referred to as the 2.4 GHz and 5 GHz frequency bands, respectively. Many newer WiFi networks also support communications in the 5.935-7.125 GHz frequency range, which is referred to as the 6 GHz frequency band. The CBRS frequency band is the 3.550-3.700 GHz frequency range. Each antenna unit 230 may include one or more antenna arrays, where each antenna array includes one or more radiating elements. In an example embodiment, each antenna unit 230 may include at least one linear array of radiating elements such as, for example, linear arrays of radiating elements that include between two and six radiating elements that are stacked in the vertical direction.

In one example embodiment, the radio unit 210 may include a single two-port radio that supports multi-input-multi-output (“MIMO”) communication techniques. MIMO refers to a communication technique in which a baseband data stream is sub-divided into multiple sub-streams that are used to generate multiple RF signals that are transmitted through multiple different antenna arrays. The antenna arrays are, for example, spatially separated from one another and/or at orthogonal polarizations so that the transmitted RF signals will be sufficiently decorrelated. The multiple RF signals are recovered at the receiver and demodulated and decoded to recover the original data sub-streams, which are then recombined. The use of MIMO transmission techniques may help overcome the negative effects of multipath fading, and may be particularly effective in urban environments where reflections may increase the level of decorrelation between the RF signals. Typically, cellular operators desire antennas that support at least 4×MIMO communications, meaning that the base station antenna must generate four decorrelated antenna beams. If each antenna unit 230 includes a single linear array of dual-polarized radiating elements, base station 200 may support 2×MIMO communications as the radio unit may divide a baseband data stream that is to be transmitted into two sub-streams that are modulated and provided to the base station antenna 220 so that two RF signals (one for each sub-stream) may simultaneously be transmitted by base station antenna 220 at the two orthogonal polarizations supported by the dual-polarized radiating elements. In another example embodiment, the radio unit 210 may include a single four-port MIMO radio, and each antenna unit 230 includes a two linear arrays of dual-polarized radiating elements so that base station 200 may support 4×MIMO communications. In still other embodiments, the radiating elements may be configured as multi-band radiating elements that support communications in two different frequency bands (e.g., the 5 GHz frequency band and the 6 GHz frequency band). In such embodiments, the radio unit 210 may include two MIMO radios, and diplexers may be provided that are used route RF signals between the radios and the feed network. These multi-band embodiments may have a single antenna array per antenna unit 230 and two-port MIMO radios or may have a pair of antenna arrays per antenna unit 230 and four-port MIMO radios.

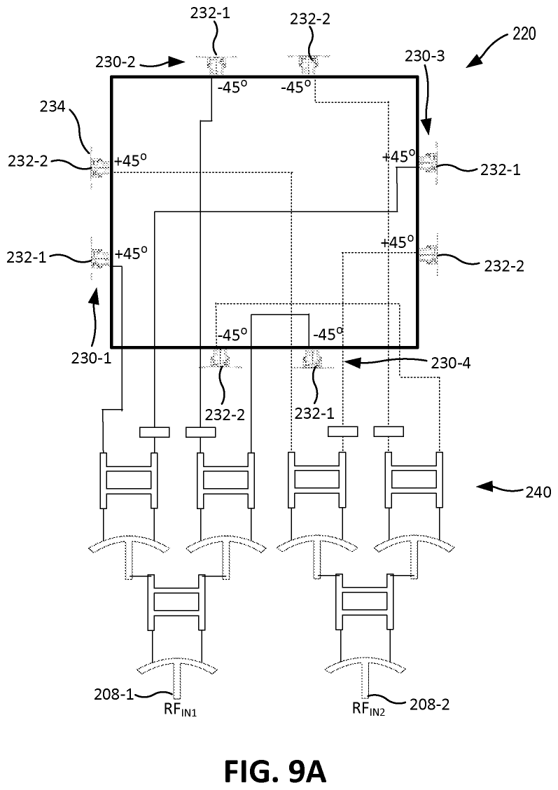

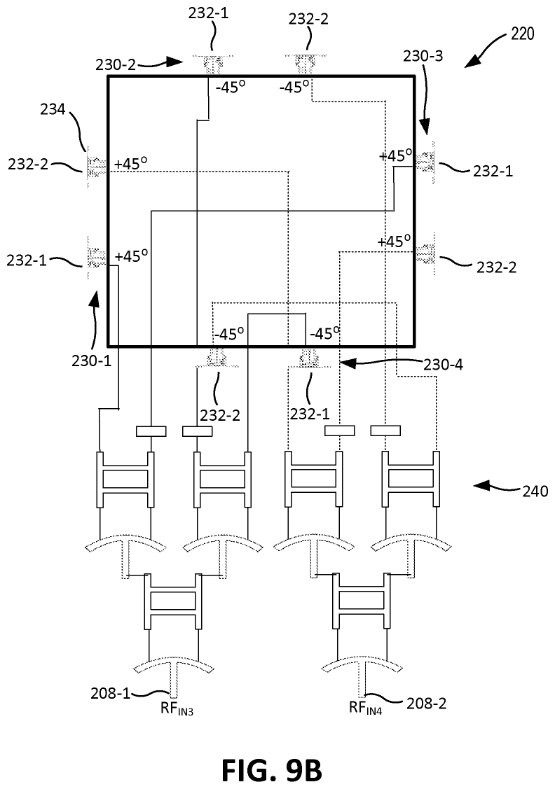

FIGS. 9A and 9B are block diagrams of the base station antenna 220 and a feed network 240 of one example embodiment of the base station 200 of FIGS. 8A-8B where the base station 200 is configured to support 4×MIMO communication techniques in one or more frequency bands. FIGS. 9A and 9B together illustrate the connections between the outputs of the feed network 240 and the linear arrays 232 of radiating elements 234 that are included in the base station antenna 220. The view of the base station antenna 220 is a top view so that only the uppermost radiating element 234 in each linear array 232 is visible in FIGS. 9A-9B. Half of the feed network is shown in FIG. 9A and the other half is shown in FIG. 9B to allow enlarging the individual elements in the drawings.

As shown in FIG. 9A, in some embodiments, each antenna unit 230 includes two linear arrays 232-1, 232-2 of dual-polarized radiating elements 234. The four antenna units 230-1 through 230-4 are arranged to extend from the four sides of the radio unit 210 so that the linear arrays 232 of the first and third antenna units 230-1, 230-3 point in opposed directions, and so that the linear arrays 232 of the second and fourth antenna units 230-2, 230-4 point in opposed directions. Each antenna unit 230 is separated from two adjacent antenna units 230 by radial angles of +90° and −90°. Each antenna unit 230 may be designed to provide coverage to a 90° sector in the azimuth plane.

As is shown in FIG. 9A-9B, the feed network 240 of base station 200 may comprise four of the feed networks 110″ that are shown in FIG. 6. It will be appreciated that FIG. 6 illustrates the feed network for an antenna that comprises four single-polarization antenna arrays (or, alternatively, the feed network for the first polarization radiators of an antenna that comprises four dual-polarization antenna arrays). Since base station antenna 220 includes eight dual-polarization antenna arrays, four of the feed networks of FIG. 6 are required in base station 200.

The portion of the feed network 240 that is shown on the left side of FIG. 9A is used to connect a first RF port 208-1 to the first linear array 232-1 of each antenna unit 230. In particular, the portion of the feed network 240 that is shown on the left side of in FIG. 9A connects the first RF port 108-1 to (1) the +45° radiators of the radiating elements 234 in the first linear array 232-1 of the first antenna unit 230-1, (2) the −45° radiators of the radiating elements 234 in the first linear array 232-1 of the second antenna unit 230-2, (3) the +45° radiators of the radiating elements 234 in the first linear array 232-1 of the third antenna unit 230-3, and (4) the −45° radiators of the radiating elements 234 in the first linear array 232-1 of the fourth antenna unit 230-4. The portion of the feed network 240 that is shown on the right side of FIG. 9A is used to connect a second RF port 208-2 to the second linear array 232-2 of each antenna unit 230. In particular, the portion of the feed network 240 that is shown on the right side of FIG. 9A connects the second RF port to (1) the +45° radiators of the radiating elements 234 in the second linear array 232-2 of the first antenna unit 230-1, (2) the −45° radiators of the radiating elements 234 in the second linear array 232-2 of the second antenna unit 230-2, (3) the +45° radiators of the radiating elements 234 in the second linear array 232-2 of the third antenna unit 230-3, and (4) the −45° radiators of the radiating elements 234 in the second linear array 232-2 of the fourth antenna unit 230-4. As described in detail above with reference to FIGS. 7A-7O, the feed network 240 may direct the power of RF signals that are input to the first and second RF ports 208-1, 208-2 so that the antenna 220 may support any of fifteen different operating modes depending upon the setting of the adjustable phase shifters in the feed network 240.

FIG. 9B shows the connections between the second half of the feed network 240 and the linear arrays 232. As can be seen, the portion of the feed network 240 shown in FIG. 9B similarly connects third and fourth RF ports 208-3, 208-4 to the eight linear arrays 232 of radiating elements 234 in a similar manner to that shown in FIG. 9A. As the connections are essentially identical, further description of FIG. 9B will be omitted.

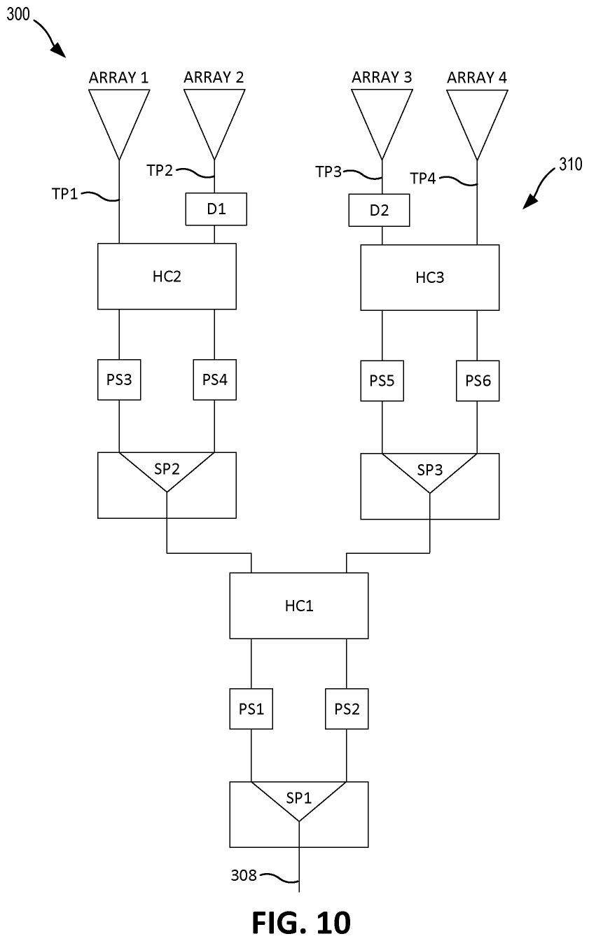

FIG. 10 is a block diagram of a multi-mode 4-sector antenna 300 according to further embodiments of the invention. The multi-mode 4-sector antenna 300 includes an RF input port 308, a feed network 310 and four antenna arrays ARRAY1 through ARRAY 4. The antenna arrays ARRAY 1 through ARRAY 4 may be identical to the antenna arrays shown in FIG. 6, and hence further description thereof will be omitted here.

As shown in FIG. 10, the feed network 310 comprises a plurality of splitters SP1 through SP3, a plurality of phase shifters PS1 through PS6 and a plurality of 4-port combiners HC1 through HC3. An RF input port 308 is coupled to the input of the first splitter SP1. The first splitter SP1 splits RF signals input thereto into two sub-components that are output at the two outputs of the first splitter SP1. The first output of the first splitter PS1 is coupled to a first phase shifter PS1, and the second output of the first splitter PS1 is coupled to a second phase shifter PS2. The output of the first phase shifter PS1 is coupled to a first input of a first four-port coupler HC1 (e.g., a 90° or 180° hybrid coupler), and the output of the second phase shifter PS2 is coupled to a second input of the first four-port coupler HC1. The first output of the four-port coupler HC1 is coupled to an input of a second splitter SP2, and the second output of the four-port coupler HC1 is coupled to an input of a third splitter SP3. The second splitter SP2 splits RF signals input thereto into first and second sub-components that are output to respective third and fourth phase shifters PS3, PS4. The outputs of the third and fourth phase shifters PS3, PS4 are coupled to the respective first and second inputs of a second four-port coupler HC2 (e.g., a 90° or 180° hybrid coupler). The first output of the second four-port coupler HC2 is coupled to a first antenna array ARRAY 1 and the second output of the second four-port coupler HC2 is coupled to a second antenna array ARRAY 2. Similarly, the third splitter SP3 splits RF signals input thereto into first and second sub-components that are output to respective fifth and sixth phase shifters PS5, PS6. The outputs of the fifth and sixth phase shifters PS5, PS6 are coupled to the respective first and second inputs of a third four-port coupler HC3 (e.g., a 90° or 180° hybrid coupler). The first output of the third four-port coupler HC3 is coupled to a third antenna array ARRAY 3 and the second output of the third four-port coupler HC2 is coupled to a fourth antenna array ARRAY 4.

The first through third splitters SP1 through SO3 may be any type of power splitter (e.g., a Wilkinson power divider) and may be configured to equally split the power of input RF signals between the two output ports. The first through sixth phase shifters PS1 through PS6 may be any type of adjustable phase shifter (e.g., electronic or electromechanical) and may be analog or digital. Since the phase difference between the sub-components of the RF signals that are output from each splitter are relative, it will be appreciated that in other embodiments a phase shifter may only be provided along one of the two paths between a splitter and an associated combiner

In the drawings and specification, there have been disclosed typical preferred embodiments of the invention and, although specific terms are employed, they are used in a generic and descriptive sense only and not for purposes of limitation, the scope of the invention being set forth in the following claims.

1. A multi-mode antenna, comprising:
a first radio frequency (“RF”) signal input;
a first array of radiating elements;
a second array of radiating elements;
a third array of radiating elements;
a fourth array of radiating elements; and
a feed network that connects the first RF signal input to the first through fourth arrays of radiating elements, the feed network comprising a plurality of hybrid couplers and a plurality of adjustable phase shifters, where the adjustable phase shifters are configurable to route substantially all of the power of an RF signal that is input at the first RF signal input to a selected one of any of the first through fourth arrays of radiating elements, or to split the power equally between all four of the first through fourth arrays of radiating elements.

2. The multi-mode antenna of claim 1, wherein the adjustable phase shifters are further configurable to route substantially all of the power of the RF signal input at the first RF signal input to any combination of two of the first through fourth arrays of radiating elements or to any combination of three of the first through fourth arrays of radiating elements.

3. (canceled)

4. The multi-mode antenna of claim 1, wherein the plurality of hybrid couplers comprises first through third hybrid couplers that each have first and second input ports and first and second output ports, where the first hybrid coupler is on an electrical path between the first RF signal input and the second and third hybrid couplers, and wherein the first output port of the second hybrid coupler is coupled to the first array of radiating elements, the second output port of the second hybrid coupler is coupled to the second array of radiating elements, the first output port of the third hybrid coupler is coupled to the third array of radiating elements, and the second output port of the third hybrid coupler is coupled to the fourth array of radiating elements.

5. The multi-mode antenna of claim 4, wherein a first electrical length of a first transmission path between the first output port of the second hybrid coupler and the first array of radiating elements is different than a second electrical length of a second transmission path between the second output port of the second hybrid coupler and the second array of radiating elements.

6. The multi-mode antenna of claim 4, wherein a third electrical length of a third transmission path between the first output port of the third hybrid coupler and the third array of radiating elements is different than a fourth electrical length of a fourth transmission path between the second output port of the third hybrid coupler and the fourth array of radiating elements.

7. The multi-mode antenna of claim 6, wherein the first electrical length is equal to the fourth electrical length.

8. The multi-mode antenna of claim 7, wherein the second electrical length is equal to the third electrical length.

9. The multi-mode antenna of claim 1, wherein the radiating elements in the first through fourth arrays of radiating elements are dual-polarized radiating elements, the RF signal is a first RF signal, the plurality of hybrid couplers are a first plurality of hybrid couplers, the plurality of adjustable phase shifters are a first plurality of adjustable phase shifters, and the feed network is a first feed network that is coupled to the first polarization radiators of the dual-polarized radiating elements in the first through fourth arrays of radiating elements, the multi-mode antenna further comprising a second RF signal input and a second feed network, where the second feed network connects the second RF signal input to the second polarization radiators of the dual-polarized radiating elements in the first through fourth arrays of radiating elements, the second feed network comprising a second plurality of hybrid couplers and a second plurality of adjustable phase shifters, where the adjustable phase shifters in the second plurality of adjustable phase shifters are configurable to route substantially all of the power of a second RF signal input at the second RF signal input to a selected one of any of the first through fourth arrays of radiating elements or to split the power equally between all four of the first through fourth arrays of radiating elements.

10. A multi-mode antenna, comprising:
a first radio frequency (“RF”) signal input;
a first array of radiating elements;
a second array of radiating elements;
a third array of radiating elements;
a fourth array of radiating elements;
a feed network that connects the first RF signal input to the first through fourth arrays of radiating elements, the feed network comprising:
a second hybrid coupler that has a first output that is connected to the first array of radiating elements and second output that is connected to the second array of radiating elements;
a third hybrid coupler that has a first output that is connected to the third array of radiating elements and second output that is connected to the fourth array of radiating elements; and
a first fixed delay element provided along a second transmission path between the second output port of the second hybrid coupler and the second array of radiating elements so that a first electrical length of a first transmission path between the first output port of the second hybrid coupler and the first array of radiating elements is less than a second electrical length of the second transmission path.

11. The multi-mode antenna of claim 10, wherein the feed network further comprises a second fixed delay element provided along a third transmission path between the first output port of the third hybrid coupler and the third array of radiating elements so that a fourth electrical length of a fourth transmission path between the second output port of the third hybrid coupler and the fourth array of radiating elements is less than a third electrical length of the third second transmission path.

12-13. (canceled)

14. The multi-mode antenna of claim 11, wherein the feed network further comprises:
a third hybrid coupler;
a first adjustable phase shifter;
a second adjustable phase shifter; and
a third adjustable phase shifter,
wherein the first adjustable phase shifter is coupled between the first RF signal input and first and second inputs of the first hybrid coupler, wherein a first output of the first hybrid coupler is coupled to first and second inputs the second hybrid coupler through the second adjustable phase shifter, and a second output of the first hybrid coupler is coupled to first and second inputs the third hybrid coupler through the third adjustable phase shifter.

15. The multi-mode antenna of claim 14, wherein the first through third adjustable phase shifters are configurable to route substantially all of the power of an RF signal input at the first RF signal input to a selected one of any of the first through fourth arrays of radiating elements or to split the power equally between all four of the first through fourth arrays of radiating elements.

16. The multi-mode antenna of claim 15, wherein the first through third adjustable phase shifters are further configurable to route substantially all of the power of the RF signal input at the first RF signal input to any combination of two of the first through fourth arrays of radiating elements or to any combination of three of the first through fourth arrays of radiating elements.

17. (canceled)

18. A multi-mode antenna, comprising:
a first radio frequency (“RF”) signal input;
a first array of radiating elements;
a second array of radiating elements;
a third array of radiating elements;
a fourth array of radiating elements; and
a feed network that connects the first RF signal input to the first through fourth arrays of radiating elements, the feed network comprising:
a second hybrid coupler that has a first output that is connected to the first array of radiating elements and second output that is connected to the second array of radiating elements; and
a third hybrid coupler that has a first output that is connected to the third array of radiating elements and second output that is connected to the fourth array of radiating elements,
wherein the multi-mode antenna is configured to operate in a selected one of a plurality of pre-programmed operating modes that includes an operating mode where about 25% of a power level of an RF signal input at the RF signal input is passed to the first output of the second hybrid coupler, about 25% of the power level of the RF signal input at the RF signal input is passed to the second output of the second hybrid coupler, and about 50% of a power level of an RF signal input at the RF signal input is passed to either the first output or the second output of the third hybrid coupler.

19. The multi-mode antenna of claim 18, wherein the feed network further comprises:
a first hybrid coupler; and
a first adjustable phase shifter that is coupled between the first RF signal input and first and second inputs of the first hybrid coupler.

20. The multi-mode antenna of claim 19, wherein the feed network further comprises:
a second adjustable phase shifter that is coupled between a first output of the first hybrid coupler and first and second inputs of the second hybrid coupler; and
a third adjustable phase shifter that is coupled between a second output of the first hybrid coupler and first and second inputs of the third hybrid coupler.

21. The multi-mode antenna of claim 20, wherein the feed network further comprises a first fixed delay element provided along a second transmission path between the second output port of the second hybrid coupler and the second array of radiating elements.

22. The multi-mode antenna of claim 21, wherein a first electrical length of a first transmission path between the first output port of the second hybrid coupler and the first array of radiating elements is less than a second electrical length of the second transmission path.

23. The multi-mode antenna of claim 22, wherein the feed network further comprises a second fixed delay element provided along a third transmission path between the first output port of the third hybrid coupler and the third array of radiating elements.

24. The multi-mode antenna of claim 23, wherein a fourth electrical length of a fourth transmission path between the second output port of the third hybrid coupler and the fourth array of radiating elements is less than a third electrical length of the third transmission path.

25-27. (canceled)
